(19) United States
(12) Patent Application Publication
(10) Pub. No.: US 2025/0270114 A1
(43) Pub. Date: Aug. 28, 2025

(54) WASTEWATER TREATMENT SYSTEM AND METHODS UTILIZING CHEMICAL PRE-TREATMENT AND FOAM FRACTIONATION

(71) Applicant: AQUA-TERRA CONSULTANTS, Bellevue, WA (US)

(72) Inventor: Alan ISMOND, Bellevue, WA (US)

(21) Appl. No.: 18/699,080

(22) PCT Filed: Oct. 7, 2022
(86) PCT No.: PCT/US2022/046099

§ 371 Date: Apr. 5, 2024

Related U.S. Application Data
(60) Provisional application No. 63/253,937, filed on Oct. 8, 2021.

(51) Int. Cl. C02F 1/24; C02F 1/52; C02F 1/66; C02F 1/72; C02F 101/38; C02F 103/32

(52) U.S. Cl. CPC C02F 1/24; C02F 1/5236; C02F 1/66; C02F 1/722; C02F 2101/38; C02F 2103/32

(57) ABSTRACT

A two-step process for recovering useable solids from food processing wastewater and for significantly reducing the pollutants, chemical, bacterial, and viral load. The first step is the addition of pretreatment chemicals such as metal-based coagulant, pH adjuster, oxidant or a combination thereof. The second step is pumping the chemically pretreated wastewater into a foam fractionation system where a gas is introduced into the chemically treated wastewater to create a rising foam that captures and remove solid materials from the remaining wastewater effluent. The solids are recovered for additional post-processing and the effluent is discharged for post-processing or to existing bodies of water.

### TECHNICAL FIELD

The present disclosure is directed to wastewater treatment system and methods and more specifically, to systems and methods utilizing chemical pre-treatment to flocculate and coagulate wastewater and foam fractionation to separate and recover solids from remaining treated wastewater effluent.

### BACKGROUND

### Description of the Related Art

Wastewater from food processing plants, such as poultry and meat slaughterhouses, seafood processing plants, and other types of food processing plants, often contains high levels of unrecovered organic product which can have an adverse environmental impact if discharged to a local treatment plant or directly to various bodies of water, such as streams, lakes, reservoirs, or the ocean. As such, various governmental bodies have imposed limits on such food processing plants through wastewater discharge permits, which establish acceptable chemical and organic matter limits on wastewater that is to be discharged from the processing plant to treatment plants or to bodies of water. In addition, private parties, such as owners of waste treatment plants, fertilizer processing plants, compost processing plants, and landfills, have imposed restrictions on the composition of incoming products, and have refused to accept waste containing certain chemicals, bacteria, and viruses.

Prior responses to meet the chemical and organic matter limits imposed above have included treatment of wastewater with a variety of coagulants to create a very fine floc that is difficult to recover and dewater unless additional flocculants are added. For example, polyacrylamide-based anionic polymers have been used in combination with Dissolved Air Flotation (DAF) systems and methods to separate the resultant sludge from remaining wastewater. Then, the wastewater was discharged to existing outfalls and the sludge was sent to one of several locations for additional processing, including rendering plants to make feeds, composting plants to make fertilizer, or to landfills. However, prior regulations and wastewater discharge permits governing the treated wastewater and the solid material separated from the wastewater allowed for compliance even though environmentally harmful chemicals, bacteria, and viruses are present in the wastewater, the solids, or both.

With a growing emphasis on minimizing chemical contaminants in food and water, and a product premium that comes with organic certification for feeds and fertilizers, there is growing pressure to phase out sludge with polyacrylamides, and other harmful chemicals, bacteria, and viruses. For example, landfills are refusing to accept this sludge due to leachate and space concerns. In response, governmental agencies have enacted new regulations and wastewater discharge permit requirements that significantly reduce or limit the type and concentration of environmentally harmful chemicals, bacteria, and viruses that may be present in wastewater and solid material separated from the wastewater prior to further downstream processing. Instead, the new regulations and permits only allow for use of more environmentally friendly chemicals, and contain new limits on bacteria and virus content in wastewater and solids.

These new regulations have significantly hindered the efficiency and efficacy of existing wastewater treatment systems and methods in removing solid material from wastewater. More specifically, existing processes are only able to achieve separation of solid material utilizing restricted chemicals and are not adapted to efficiently separate solid materials using approved chemicals only. Further, to the extent that existing systems and methods can successfully separate the solids, these existing systems and methods fail to meet the requirements concerning bacteria and virus content in the wastewater and the separated solids. In some cases, these regulations and permit requirements have rendered prior systems inoperable, as it is impossible to either remove the solids or satisfy the composition requirements using existing systems and methods.

In response, some wastewater processing plants have treated their wastewater with biological treatment systems. However, these systems usually require physiochemical pretreatment, more space, and a constant and homogeneous supply of wastewater, which create operational inefficiencies and increase cost. In some cases, the wastewater temperature and salinity combined with seasonal operation, such as would be present in a seafood wastewater treatment plant, make biological treatment unpractical.

### BRIEF SUMMARY

The present disclosure describes systems, devices, and methods for separating solids from wastewater having high amounts of organic matters (e.g., seafood processing wastewater) using a two-step process in a manner that allows those solids to be recovered for feeds and fertilizer. The resultant wastewater is significantly lower in pollutants (particularly organic pollutants), bacteria and viruses. More specifically, a first step includes chemical pretreatment of incoming wastewater with one or more of pretreatment chemicals such as ferric sulfate, peracetic acid, citric acid, sodium hydroxide, calcium hydroxide, sodium bicarbonate, sulfuric acid, hydrogen peroxide and the like, acting in various capabilities as coagulants/flocculants, pH adjusters, oxidants, disinfectants or a combination thereof. The pretreatment chemicals coagulate and flocculate the solid material (e.g., organic matters) in the wastewater while neutralizing or killing certain bacteria and viruses in the solid material and the wastewater. The pretreated wastewater is then provided to a foam fractionation system for further processing in a second step. The second step includes separating the coagulated and flocculated solids using a foam fractionation tower. A foam fractionation tower includes a reservoir wherein a gas-water interface is achieved by injecting air, ozone, or other like gases into the water in the reservoir, which results in production of foam. Solid materials adhere to the foam and rise along the reservoir for collection, leaving clean effluent without solids near a base of the reservoir for discharge to an existing outfall and/or to an ultra-violet disinfectant system.

For example, one or more embodiments of a method include: pretreating wastewater containing organic matters, the pretreating including adding one or more pretreatment chemicals to the wastewater to form a pretreated wastewater mixture, wherein the one or more pretreatment chemicals are metal-based coagulants, pH adjusters, oxidants or a combination thereof; and supplying the pretreated wastewater mixture into a foam fractionation system, whereby the pretreated wastewater mixture is separated into a foamate and an effluent within the foam fractionation system, wherein the foamate comprises foams on which at least a portion of the organic matters are adsorbed.

The method may further include: the one or more pretreatment chemicals including at least two of a metal-based coagulant, a pH adjuster, and an oxidant, or a combination thereof; the one or more pretreatment chemicals being sulfuric acid, ferric sulfate, sodium bicarbonate, sodium hydroxide, hydrogen peroxide, peracetic acid or a combination thereof; the pretreating the wastewater further including adding the metal-based coagulant first, adding the oxidant second, and adding the pH adjuster third to form the pretreated wastewater mixture; the pretreating the wastewater including adjusting a pH of the pretreated wastewater mixture to a level at or below an isoelectric point of the proteins in the wastewater; and the pretreating the wastewater further including adding one or more of sulfuric acid, sodium bicarbonate, and hydrogen peroxide to the wastewater to form the pretreated wastewater mixture.

The method may further include: the supplying of the pretreated wastewater mixture into the foam fractionation system including pumping the pretreated wastewater mixture into the foam fractionation system proximate a first end or top of the foam fractionation system opposite a base of the foam fractionation system; the supplying the pretreated wastewater mixture into the foam fractionation system further including operating the foam fractionation system countercurrently; after the supplying, discharging the effluent proximate the base of the foam fractionation tower; after the supplying, discharging the effluent, the discharging including flowing the effluent through at least one of a mesh screen or an ultraviolet treatment system to provide a refined effluent and discharging the refined effluent to a wastewater discharge; after the supplying, discharging the foamate from a first end of the foam fractionation tower opposite a base of the foam fractionation tower; after the discharging the foamate, dewatering the foamate, the dewatering the foamate including separating water from the foamate by gravity separation in a sludge tank; and the dewatering the foamate further including, before separating water from the foamate, adjusting a pH of the foamate and adding chitosan to the foamate.

One or more embodiments of a system include: a chemical pretreatment system, the chemical pretreatment system including: a feed pump; at least one chemical pump downstream from the feed pump and in fluid communication with the feed pump; and a floc tube in fluid communication with the at least one chemical pump and the feed pump; and a foam fractionation system in fluid communication with the chemical pretreatment system, the foam fractionation system including: a reservoir having a fluid inlet, a fluid outlet, and a foamate outlet, the reservoir further including a first end; a gas injection pump in fluid communication with the reservoir through a fluid loop coupled between the gas injection pump and the first end of the reservoir; and a gas source upstream of the gas injection pump and in fluid communication with the gas injection pump.

The system may further include: at least one equalization tank upstream of the feed pump of the chemical pretreatment system and in fluid communication with the feed pump, wherein during operation, the at least one equalization tank provides wastewater to the feed pump; a flow outlet path in fluid communication with the fluid outlet of the reservoir, and a screen in the flow outlet path downstream from the reservoir, wherein the screen receives effluent from the fluid outlet of the reservoir; an ultraviolet treatment system in fluid communication with the flow outlet path downstream from the screen, wherein the ultraviolet treatment system receives effluent from screen and discharges purified effluent to a discharge; and the at least one chemical pump including at least three chemical pumps, wherein a first one of the at least three chemical pumps provides ferric sulfate to wastewater from the feed pump.

The system may further include: a second one of the at least three chemical pumps providing peracetic acid to the wastewater and a third one of the at least three chemical pumps providing sodium hydroxide to the wastewater; a sludge tank in fluid communication with the foamate outlet of the reservoir, wherein the sludge tank receives and holds foamate separated from effluent in the reservoir; a decantate line fluidly connected between the sludge tank and a wastewater sump in fluid communication with the at least one equalization tank and upstream of the at least one equalization tank, wherein during operation, the decantate line provides decantate separated from solid material in the sludge tank to the wastewater sump, where the wastewater sump provides the decantate to the equalization tank in a fluid loop; the gas source being an ozone generator; the at least one chemical pump providing one or more pretreatment chemicals to wastewater in the chemical pretreatment system, wherein the one or more pretreatment chemicals are metal-based coagulants, pH adjusters, oxidants, or a combination thereof; and wherein the one or more pretreatment chemicals are sulfuric acid, ferric sulfate, sodium bicarbonate, sodium hydroxide, hydrogen peroxide, peracetic acid, or a combination thereof.

One or more embodiments of a method include: pretreating wastewater containing organic matters, the pretreating including adding one or more pretreatment chemicals to the wastewater to form a pretreated wastewater mixture, wherein the one or more pretreatment chemicals are metal-based coagulants, pH adjusters, oxidants or a combination thereof; and supplying the pretreated wastewater mixture into a foam fractionation system, whereby the pretreated wastewater mixture is separated into a foamate and an effluent within the foam fractionation system, wherein the foamate comprises foams on which at least a portion of the organic matters are adsorbed.

The method may further include: the metal-based coagulant being ferric sulfate, the pH adjuster being sodium bicarbonate, sodium hydroxide, or sulfuric acid, and the oxidant being hydrogen peroxide, peracetic acid or a combination thereof; the pretreating including passing the wastewater containing organic matters through a floc tube and supplying the pretreated wastewater mixture into the foam fractionation system in real-time based on an influent of the wastewater containing organic matters; the pretreating including introducing all of the one or more pretreatment chemicals at the floc tube to form the pretreated wastewater mixture; before the pretreating the wastewater containing organic matters, storing the influent of the wastewater containing organic matters in one or more equalization tanks in fluid communication with the floc tube for less than 12 hours; and the one or more pretreatment chemicals including at least a first pretreatment chemical and at least a second pretreatment chemical, the pretreating the wastewater containing organic matters including adding at least the first pretreatment chemical to the wastewater upstream of a floc tube and at least the second pretreatment chemical to the wastewater at the floc tube.

The method may further include: the adding the at least the first pretreatment chemical including adding at least the first pretreatment chemical to the wastewater at least 12 hours in advance of adding the at least the second pretreatment chemical to the wastewater; the pretreating the wastewater containing organic matters occurring at least 12 hours before supplying the pretreated wastewater mixture to the foam fractionation system; and before the pretreating the wastewater containing organic matters, storing the influent of the wastewater containing organic matters in one or more equalization tanks in fluid communication with the floc tube for less than 12 hours.

The method may further include: the adding at least the first pretreatment chemical to the wastewater including adding at least the first pretreatment chemical to the wastewater at the one or more equalization tanks; before supplying the pretreated wastewater mixture into the foam fractionation system, allowing the wastewater containing organic matters to settle in the one or more equalization tanks for a period of time, the settling including separating solid matter from liquid in the wastewater; and before supplying the pretreated wastewater mixture into the foam fractionation system, pumping the solid matter from the one or more equalization tanks to one or more decantation tanks.

One or more embodiments of a system include: a chemical pretreatment system, the chemical pretreatment system including one or more equalization tanks, a floc tube in fluid communication with the one or more equalization tanks, at least one chemical pump in fluid communication with at least one of the one or more equalization tanks and the floc tube, a foam fractionation system in fluid communication with the chemical pretreatment system, the foam fractionation system including a reservoir having a fluid inlet, a fluid outlet, and a foamate outlet, the reservoir further including a first end, a gas injection pump in fluid communication with the reservoir through a fluid loop coupled between the gas injection pump and the first end of the reservoir, and a gas source upstream of the gas injection pump and in fluid communication with the gas injection pump.

The system may further include: the at least one chemical pump including one or more first chemical pumps and one or more second chemical pumps, the one or more first chemical pumps in fluid communication with the one or more equalization tanks and the one or more second chemical pumps in fluid communication with the floc tube; the one or more first chemical pumps providing ferric sulfate or peracetic acid, or both, to wastewater in the one or more equalization tanks; the one or more second chemical pumps providing at least one of ferric sulfate, sodium bicarbonate, sodium hydroxide, sulfuric acid, hydrogen peroxide, peracetic acid or a combination thereof to wastewater in the floc tube; the at least one chemical pump including a plurality of first chemical pumps upstream of the one or more equalization tanks and a plurality of second chemical pumps at the floc tube; and the plurality of first chemical pumps and the plurality of second chemical pumps providing pretreatment chemicals to wastewater in the chemical pretreatment system, the pretreatment chemicals including metal-based coagulants, pH adjusters, oxidants, caustic agents, or combination thereof.

### BRIEF DESCRIPTION OF THE SEVERAL VIEWS OF THE DRAWINGS

For a better understanding of the embodiments, reference will now be made by way of example only to the accompanying drawings. In the drawings, identical reference numbers identify similar elements or acts. In some figures, the sizes and relative positions of elements in the drawings are not necessarily drawn to scale.

FIG. 1 is a schematic of an embodiment of a system for producing wastewater from salmon processing.

FIG. 2 is a schematic of an embodiment of a system for processing wastewater.

FIG. 3 is a schematic of a chemical pretreatment system of the system of FIG. 2 illustrating an equalization tank, a feed pump, at least one chemical pump, and a floc tube in fluid communication with each other.

FIG. 4 is a schematic of a foam fractionation system of the system of FIG. 2 illustrating a reservoir, a gas injection pump, and a gas source in fluid communication with each other.

FIG. 5 is a graphical representation of multiwave spectrophotometer data for raw wastewater and chemically pretreated wastewater after foam fractionation according to an embodiment of the present disclosure.

FIG. 6 is a graphical representation of multiwave spectrophotometer data for raw wastewater, raw wastewater after chemical pretreatment and settlement, and two runs of chemically pretreated wastewater after foam fractionation according to an embodiment of the present disclosure.

FIG. 7 is a graphical representation of multiwave spectrophotometer data for raw wastewater and chemically pretreated wastewater after foam fractionation according to an embodiment of the present disclosure.

FIGS. 8A-8C are schematics of an embodiment of a system for processing wastewater.

FIG. 9 is a schematic of an embodiment of a foam fractionation system including an extension ring of the system of FIG. 8A-8C.

### DETAILED DESCRIPTION

Wastewater having significant amounts of organic matters (e.g., protein, fat, blood) is unsuited for conventional purification systems due to the high biological oxygen demand (BOD), chemical oxygen demand (COD) and total organic carbons (TOC). The present disclosure is directed to separating or recovering solids, especially solids rich with organic matters such as protein and fat, from wastewater in a process involving at least a chemical pretreatment step and a foam fractionation step. The process disclosed herein avoids using polymers such as polyacrylamide, thereby allowing the recovered solids, free of added polymers, to be used for feeds and fertilizer, or to be received in a landfill. The treated wastewater is significantly lower in pollutants, chemicals, bacteria and viruses compared to that of the known processes, such that the treated wastewater can be safely discharged to existing bodies of water with significantly reduced environmental impact. As used herein, “wastewater” refers to “any water that has been affected by human use.” While the present disclosure generally describes systems and methods for processing wastewater with organic matters or components, such as, without limitation, poultry and meat processing wastewater, seafood processing wastewater, fruit and vegetable processing wastewater, legume processing wastewater, winery and brewery processing wastewater, cheese processing other types of food processing plant wastewater, and aquarium wastewater, it is to be appreciated that the embodiments of the present disclosure may be adapted for use with any wastewater according to the definition above and the same is expressly contemplated in the present disclosure. Accordingly, the present disclosure is not limited to food processing wastewater.

In particular, the wastewater contains significant amounts of organic matter. In some embodiments, the wastewater contains at least 0.5% (w/v), or at least 1.0% (w/v), or at least 1.5% (w/v), or at least 2.0% (w/v), or at least 2.5% (w/v), or at least 3.0% (w/v), or at least 3.5% (w/v), or at least 4.0% (w/v), or at least 4.5% (w/v), or at least 5.0% (w/v) organic matter. In certain embodiments, the organic matter may be present in the wastewater as colloidal or particulate solids of proteins, fat, blood, cartilage, etc.

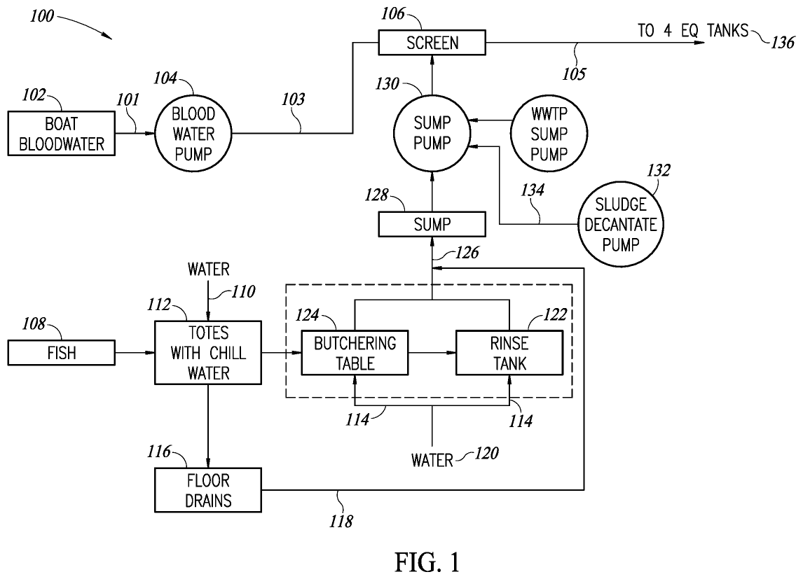

FIG. 1 is a schematic illustration of an embodiment of a system 100 for producing wastewater in a salmon processing plant and serves as an example of how wastewater is generated in a processing plant. As explained further below, seafood wastewater processing systems and methods are described herein as one non-limiting example of the embodiments of the present disclosure. Additional examples are not provided in the interest of brevity and to avoid obscuring the features of the embodiments. However, it is to be appreciated that the systems and methods described herein can be used to process other forms of food processing wastewater and wastewater generally and as such, the present disclosure is not limited to seafood processing wastewater. Rather, processing any type of wastewater is expressly contemplated with the embodiments of the present disclosure.

In an embodiment of salmon wastewater processing, the system 100 includes incoming wastewater 102 from a boat. In farmed salmon processing applications, the wastewater 102 is boat hold water that contains blood and other organic material resulting from harvesting and on-board bleeding of fish, thus creating bloodwater in the boat hold. Harvesting can include catching wild fish (e.g., pole or line caught) as well as catching or harvesting farm raised fish. Further, the boat hold water or blood water is typically combined with fresh or salt water for storing the fish in the boat hold. In wild salmon processing applications, the fish are caught and placed in the hold, either with or without water, and typically are not bled en route to the processing plant. As such, the resulting water in the boat hold may not contain blood, and may generally contain little, if any, organic material. In further applications, fish or other seafood is stored in the boat holds on ice and thus there is generally little water or organic material in the boat hold once the fish or seafood are removed upon arrival at the processing plant. In any event, the contents of the boat hold comprise incoming wastewater 102 that is provided to pump 104, as below.

The wastewater 102 is fed to a pump 104 via line 101, which may be connected to a drain, an upstream screen, or some other inlet for receiving the water 102 and conveying the water 102 along the line 101. The water 102 is pumped by the pump 104 along line 103 to a screen 106. The screen 106 filters out any large organic materials (e.g., fins, etc.) that may be present in wild fish processing applications, as well as any extraneous materials (e.g., hammers, gloves, plastics, etc.) that may be present in the system 100, such as in sump 128 described below. Such extraneous materials can be periodically removed or cleaned from the screen 106 and sent to a landfill or other disposal location.

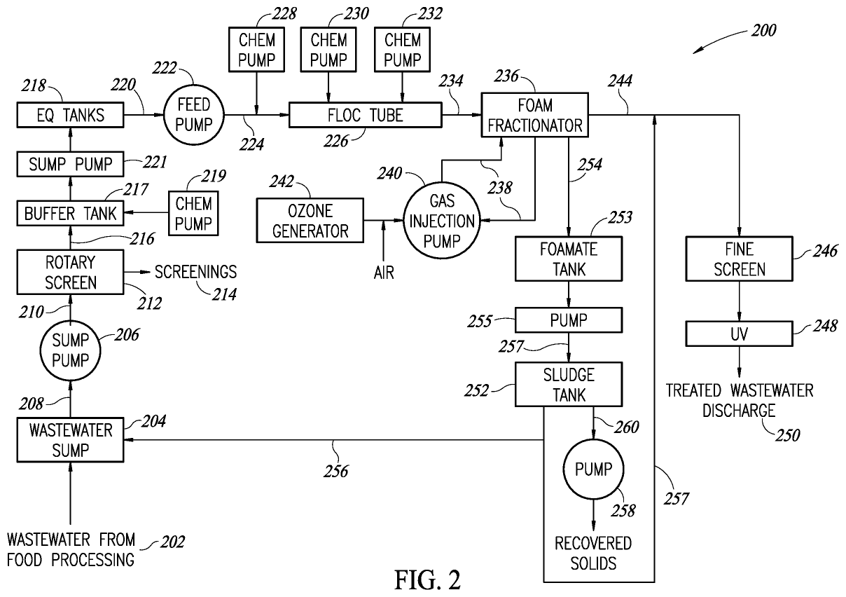

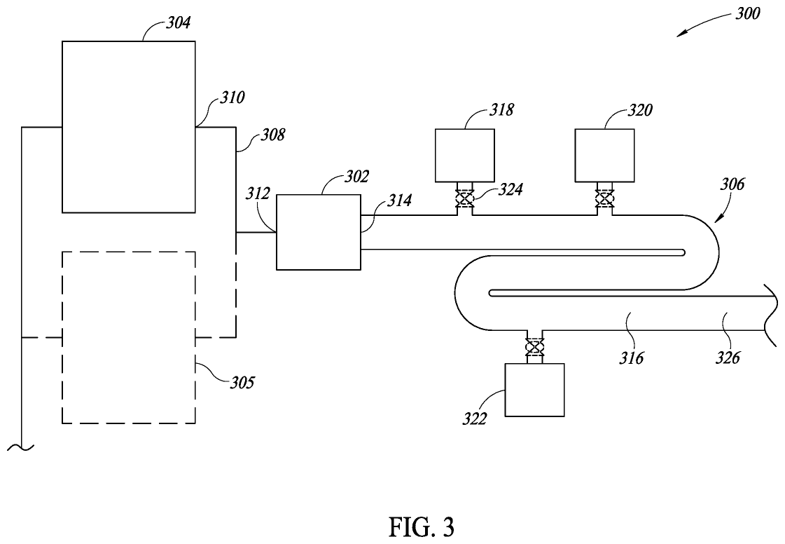

In some embodiments, the water 102 is then provided to equalization tanks 136 along line 105 for storage prior to additional processing, as described in greater detail below with reference to FIGS. 2-3. In some embodiments, the water 102 or a portion of the water 102 can be discharged to an existing outfall. The water 102 is a portion of the total wastewater collected from system 100. The wastewater in system 100 that is collected in the EQ tanks 136 further includes wastewater from cleaning harvested fish, as described below.

Fish or other seafood 108 that are removed from the boat are combined with water 110 in totes 112 for conveyance from the boat to the processing facility. At the processing facility, the fish 108 are removed from the totes 112 and provided to a butchering table 124 for processing. In farm raised fish processing plants, the fish 108 are gutted at the butchering table 124 and provided whole to a rinse tank 122 for cleaning. In wild caught fish processing embodiments, the fish are filleted at butchering table 124, and the rinse tank 122 is not necessary, as fillets are rinsed with water 120 at the butchering table 124 before packaging. In embodiments that include the rinse tank 122, water 120 is provided to both the rinse tank 122 and the butchering table 124 along lines 114, or in embodiments without the rinse tank, water 120 is provided to the butchering table 124 along line 114.

The excess water 120 from the rinse tank 122 and the butchering table 124, which contains organic matters or materials (e.g., blood, protein, oils, fats, tissues, etc.) and bacteria or viruses are provided to sump 128 along line 126, which may include, in various embodiments, one or more screens, valves, or drains between the rinse tank 122 and the sump 128 and between the butchering table 124 and the sump 128, either at an inlet to line 126, or along line 126. The sump 128 stores and provides the water 120 containing organic materials and bacteria and viruses to a sump pump 130, wherein sump pump 130 provides the water 120 to screen 106. Upon arrival at the screen 106, the process continues according to the above description. It is to be appreciated that in some embodiments, the incoming wastewater 102 may be boat bloodwater that has been combined with salt water in a boat hold, as above. As such, the salt in the water 102 from the boat hold is combined with fresh water 120 from butchering table 124 (or from some other fresh water source in the system 100) to provide wastewater 102 in tanks 136 with a salinity in the range of 5 parts per thousand to 15 parts per thousand, or more or less. As such, certain embodiments of the systems and methods described herein are adapted to process incoming wastewater, such as wastewater 102, with a salinity concentration that is higher than in many other food processing applications.

Water 110 from the totes 112 is provided to a floor drain 116, which in an embodiment, includes multiple floor drains, and is conveyed along line 118. Line 118 joins line 126, such that all of the wastewater from processing the fish 108, with the exception of the initial wastewater 102 from the boat, is provided to the sump 128. In an embodiment, a sludge decantate pump 132 provides decantate from a sludge tank to the sump pump 130, and eventually to the equalization tanks 136 for additional processing in a decantate loop, as described below.

FIG. 2 is a schematic illustrating an embodiment of a generic system 200 for processing wastewater, which in some embodiments, is food processing wastewater. System 200 includes incoming wastewater 202, which is collected in a sump 204. The wastewater 202 includes blood, salt, fats, oils, viruses, and bacteria, among other components and compounds. A sump pump 206 in fluid communication with the sump 204, either directly (e.g., with a pump inlet directly mechanically and fluidly coupled to an outlet of the sump 204) or through a line 208, pumps the wastewater 202 through a rotary screen 212. The rotary screen 212 is connected to the sump pump 206 by line 210.

In an embodiment, the rotary screen 212 includes a wedge wire drum screen, while in other embodiments, the rotary screen 212 includes some other type of rotary screen, such as a panel running screen. The wedge wire drum screen is preferably formed of stainless steel, with screen openings from 0.010 inches to 0.125 inches, or more or less, with through flow capacity up to 20 million gallons per day, or more or less. It is to be appreciated that the flow through capacity of the screen 212 can be higher than a typical flow through capacity of system 200, which may be up to 6 million gallons per day, or more or less. Screenings 214 from the wastewater 202 are sent to a solid waste treatment plant or landfill, as they may contain extraneous materials (e.g. ear plugs, gloves, tools, etc.). The screened wastewater is provided to one or more equalization tanks 218 via line 216, which is fluidly interconnected between the upstream screen 212 and the downstream tank 218. In an embodiment, the system 200 includes a plurality of equalization tanks 218 fluidly connected in series. For example, the plurality of equalization tanks 218 may include one, two, three, four, five, six, seven, eight, nine, ten or more equalization tanks 218 connected in series. Factors that influence the number of tanks 218 present within the system 200 include the total daily flow of the system 200 and available space within the processing plant, among others.

In one or more embodiments, one or more pretreatment chemicals, are added to the screened wastewater before the screened wastewater is transported to the equalization tanks 218.

In one or more embodiments, before the screened wastewater 202 is provided to the equalization tanks 218, the screened wastewater 202 first passes through a buffer tank 217. At the buffer tank 217, one or more pretreatment chemicals may be introduced to the screened wastewater 202 before storage in the equalization tanks 218. For example, the one or more chemicals may include, but are not limited to, one or more of sulfuric acid, ferric sulfate, sodium bicarbonate, sodium hydroxide, hydrogen peroxide, and peracetic acid. The one or more pretreatment chemicals may be added by one or more chemical pumps, such as chemical pump 219 in fluid communication with the buffer tank 217. The chemical pump 219 may be similar to chemical pumps 228, 230, 232 described herein, in some embodiments. The residence time in the buffer tank 217 and the equalization tanks 218 may be selected according to the wastewater to be treated. For example, in some embodiments, the screened wastewater 202 may pass directly through the buffer tank 217 (e.g., a residence time between a few seconds to a few minutes) to be stored in the equalization tanks overnight (e.g. 6 to 14 hours, or more or less). Once the screened wastewater 202 passes through buffer tank 217, a sump pump 221 pumps the screened and chemically pretreated wastewater 202 to the equalization tanks 218 for storage.

As used herein, pretreatment chemicals perform a number of functions to prepare the wastewater before foam fractionation. More specifically, the pretreatment chemicals may act as coagulants or flocculants to cause solid particles in the wastewater to form into bigger masses (e.g., flocs). Other pretreatment chemicals are pH adjusters to bring the pH of the wastewater to a range for optimizing the performance of the other chemicals, including the coagulants or flocculants. Yet other pretreatment chemicals may disinfect or reduce BOD/COD/TOC.

In certain embodiments, the pretreatment chemicals are salts of multivalent metals, such as salts of iron, aluminum, magnesium, or calcium. These metal salts are effective coagulants due to their ability of forming multi-charged polynuclear complexes with enhanced adsorption characteristics. Examples of iron salts include, without limitation, ferric sulfate, ferrous sulfate, ferric chloride, ferric chloride sulfate. Examples of aluminum salts include, without limitation, aluminum sulfate, aluminum chloride, and sodium aluminate. Examples of magnesium or calcium-based coagulants include, without limitation, hydrated lime and magnesium carbonate.

As an alternative to the metal salts, metal-based coagulants may be provided by electrocoagulation. Electrocoagulation uses a direct current source between metal electrodes (e.g., iron or aluminum) immersed in wastewater. The electrical current causes the dissolution of metal electrodes into the wastewater. The dissolved metal ions act in a similar manner as metal salt as metal-based coagulants.

The metal-based coagulants function (e.g., forming polynuclear complexes) efficiently within an optimal pH range. In certain embodiments, the pretreatment chemicals may include one or more pH adjusters. Depending on the pH of the wastewater to be pretreated and the specific metal coagulants used, an acid or base may be combined with metal-based coagulant(s). Examples of the pH adjusters include, without limitation, sulfuric acid, sodium hydroxide, sodium bicarbonate, and the like.

To further reduce the high BOD/COD/TOC loads of the wastewater according to the present disclosure, one or more oxidants may be used to pretreat the wastewater. In particular, oxidants such as peroxides are capable of degrading certain organic matters, as well as disinfecting against bacteria and virus. Examples include, without limitation, hydrogen peroxide and peracetic acid. Peracetic acid is also an acid and may perform the dual functions of a pH adjuster and an oxidant.

In an embodiment where the wastewater 202 is seafood processing wastewater, or some other form of food processing wastewater that is provided on an intermittent basis, activation of the wastewater treatment system 200 depends on when the food processing plant (e.g. the butchering table 124 and the rinse tank 122 in FIG. 1) is running and when there is sufficient inventory of wastewater in the equalization tank 218 to allow for continuous operation of the system 200. In various embodiments, sufficient inventory may mean the equalization tank is at 50% capacity, 60% capacity, 70% capacity, 80% capacity, or 90% or more capacity. In such cases, the decision to activate the system 200 may be made as a result of manual inspection, while in other embodiments, the decision to activate the system 200 is made autonomously based on a control unit in electronic communication with volume or water level sensors in the equalization tank 218, wherein when the capacity of the tank 218 reaches a predetermined threshold, such as any of those identified above, the system 200 automatically activates. In some embodiments, the control unit provides a notification to a user, such as an onsite engineer, when the operational capacity has been reached, in which case, the user manually activates the system.

In some embodiments where the wastewater 202 feed is continuous and in direct relationship to operation of the food processing plant, such as, for example, in continuous meat processing operations, the system 200 may activated along with activation of the food processing plant in general and may remain operational during operation of the plant based on a consistent supply of wastewater 202.

When the system 200 is activated, feed pump 222 is energized and the wastewater 202, after passing through the screen 212, is pumped from the equalization tank 218 through the feed pump 222 and through a floc tube 226. At least one chemical pump 228 is in fluid communication with fluid flowing through the floc tube 226, either directly, or upstream of the floc tube 226 along line 224. For example, in FIG. 2, a first chemical pump 228 is illustrated upstream of the floc tube 226, and second and third chemical pumps 230, 232, respectively, are in fluid communication with the floc tube 226. In yet further embodiments, all of the chemical pumps 228, 230, 232 are in fluid communication with fluid flowing through the floc tube 226, which as described herein, preferably includes a plurality of pipes arranged in series in a serpentine arrangement. Preferably, the system 200 includes at least three chemical pumps 228, 230, 232, wherein the chemical pumps 228, 230, 232 are arranged in sequential order based on the chemicals provided by the respective pumps. Moreover, the pumps are preferably spaced from one another along the flow path through the floc tube 226 in a predetermined amount in order to account for timing of introduction of chemicals to wastewater 202 in the floc tube 226 and appropriate amounts of mixing within the floc tube 226 between chemical additions.

In an embodiment, the first chemical pump 228 provides ferric sulfate to the wastewater 202 flowing through the floc tube 226, the second chemical pump 230 provides peracetic acid to the wastewater 202, and the third chemical pump 232 provides sodium hydroxide to the wastewater 202. In some embodiments, these chemicals are introduced to the wastewater 202 in sequential order, with ferric sulfate first, followed by peracetic acid, and finally, sodium hydroxide, although the same is not necessarily required. For example, the chemicals can be added in any number of different variations of order, such as a reverse order of the above, or any of the above chemicals first, second, and third. When ferric sulfate, peracetic acid, and sodium hydroxide are added to the wastewater 202 in the order above, the ferric sulfate and the peracetic acid lower a pH of the wastewater 202 to a level that is at or below the isoelectric point of the wastewater 202.

It is to be appreciated that the isoelectric point of the wastewater 202 is a reference value that is known or can be calculated for various food processing wastewater. Then, the pH of the wastewater is raised using sodium hydroxide to acceptable levels, which in an embodiment, is between 6.5 and 7.5. Further, the ferric sulfate and peracetic acid coagulate and flocculate solid organic materials in the wastewater 202. Moreover, the peracetic acid and the sodium hydroxide may sterilize various bacteria and viruses present in the wastewater 202, including in the solids. It is to be appreciated that in other embodiments, not all three of these chemicals are required, but rather, depending on the composition of the wastewater 202 to be treated, only one or two of these chemicals may be preferable. Further, it will be appreciated that other wastewater processing systems and methods will utilize different chemicals, including additional chemical pumps (e.g., more than 3 chemical pumps) and the present disclosure contemplates use of the same. For example, the chemicals used to treat the wastewater 202 before, at, or after the floc tube 226 may be, but are not limited to, any one or more of ferric sulfate, peracetic acid, sodium hydroxide, sodium bicarbonate, sulfuric acid, or hydrogen peroxide, either alone or in combination. These chemicals may be added to wastewater 202 in any order and with any number of chemical pumps, either before, at, or after the floc tube 226. In one non-limiting example, one or more of the pretreatment chemicals described herein can be added directly to the buffer tank 217 via chemical pump 219 and/or directly to the equalization tanks 218, which are both upstream of the floc tube 226. In other words, selection of chemicals, chemical pumps, the order of the pumps and of adding chemicals, and chemical concentration is based on the properties of the wastewater 202 input to the system, with the chemicals and ordering specified above merely being one non-limiting example.

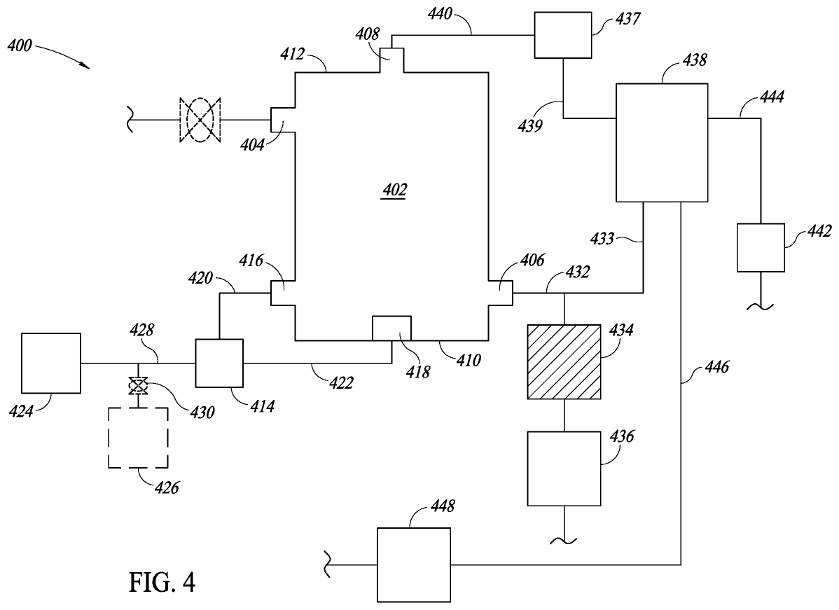

The chemically pretreated wastewater is then discharged from the floc tube 226 into a foam fractionation tower 236 via line 234. An embodiment of a foam fractionation tower 236 or a foam fractionation system will be described in additional detail with reference to FIG. 4. However, briefly, the foam fractionation tower 236 can be operated in a concurrent or counter current flow mode, wherein in either flow mode, the fractionator 236 receives the chemically pretreated wastewater from the floc tube 226. Gas is injected into the foam fractionation tower 236 via gas injection pump 240, which is in fluid communication with the foam fractionation tower 236 via a fluid loop 238. For example, the gas injection pump 240 receives wastewater from the foam fractionation tower 236, injects it with gas, and returns the wastewater with injected gas to the foam fractionation tower 236.

The injected gas creates a pneumatic foam within the foam fractionation tower 236 that bonds with solid particles that have been coagulated and flocculated during the chemical pretreatment system described above. The pneumatic force of the rising foam, which is caused in part by the difference in density between the injected gas and the wastewater and in part by the flow rate of the incoming wastewater from the injection pump 240, in combination with the adhesive force between the foam and solids, is greater than a gravitational force acting on the solid materials in a generally opposite direction, and thus the solid materials rise with the foam and are separated from the pretreated wastewater within the fractionator 236. In an embodiment, an ozone generator 242 is upstream of the gas injection pump 240 for providing ozone as the gas for injection into the wastewater. Additionally or alternatively, the gas provided by injection pump 240 may be air, either alone, or in combination with ozone. Moreover, injection of gas into the foam fractionation tower 236, in combination with settlement of liquid from the foamate in the tower during residence of the wastewater 202 in the tower 236 and the circular current within the tower, results in continuous thickening of the foamate as it moves along the tower 236.

The addition of chemicals in different concentrations and compositions, or with different gas sources, may change the properties of the foam, including water and solid concentration, among others. Thus, it is possible to vary the system to provide wetter or drier, denser foam, as needed in specific applications. For example, it is to be appreciated that controlling the rate of gas injection and throttling the liquid discharge from the tower 236 affects the level of the liquid-foam interface in the tower 236, the volume and moisture of the foamate, and the clarity of the liquid fraction or effluent discharged, along with the recovery of solids. Additionally, adjusting the feed rate to the tower 236 affects the residence time in the tower 236 and the clarity of the liquid fraction and the recovery of solids. Each of these are factors for consideration in adjusting or designing the system 200 according to the composition of specific embodiments of wastewater 202, among others. Further, injection of ozone as the gas may serve as a disinfectant to wastewater 202 in the tower 236. Viruses and bacteria may also be removed from the tower 236 through physical separation by attachment to the foamate that exits the tower 236.

It is to be appreciated that the embodiments of the foam fractionation (FF) system and methods described herein contain several advantages over DAF systems and methods. For example, DAF cannot adequately recover solids without the use of polymers, but FF can. It is believed that FF is successful for recovery of solids without addition of polymers based on a number of different parameters between the two systems including, without limitation, differences in bubble size distribution, stress state at the gas-liquid interface, rate of bubble coalescence, gas flow rate, surface tension, dimensions of the systems, run time or residence time, gas to water ratio, and surfactants, among others.

Further, FF systems and methods are advantageous because the capital cost for equivalent flow rate will be 40 to 70% lower for FF than DAF in one non-limiting example. Moreover, FF systems and methods require less monitoring and adjustment during operation, and are easier to maintain. For example, on a DAF, fine tuning involves dialing in the chemistry, adjusting the flow rate, adjusting the weir level, adjusting the skimmer timing, adjusting the percent recycle of clean water with added air, and adjusting the air pressure and flow rate. The DAF has a recirculation pump, a compressor, and a motorized skimmer. By comparison, FF systems and methods include a recirculation pump, a discharge valve, and an air adjustment valve. As such, FF systems and methods have fewer moving parts and are easier to maintain.

Further, with FF systems and methods, fine tuning includes dialing in the chemistry, adjusting the flow rate, adjusting the discharge valve, and adjusting the air flow rate. Another advantage of FF is that one can run the unit in an enrichment mode where a portion of the foamate can be recycled for further concentrating. Such recycling of the foamate is not possible with DAF systems. A further advantage of FF is that the solids content of the foamate can be increased and clean effluent can be intermittently used to backwash the foamate collection system. For plants that have multiple processing operations (e.g., fish, shrimp, crab processing plants, etc.) where the flow rate can range from 60,000 gallons per day to 600,000 gallons per day, the lower cost of a FF system versus a DAF would allow the plant to have several FF reservoirs or towers for the cost of a single DAF. As such, plants can ramp up or down the number of FF systems in service depending on the flow rate. Without the use of robust chemistry, the DAF will need to have a plate pack or baffle plates in the DAF Tank. The FF tower has no obstructions and is therefore also easier to clean. Despite the advantages of using a FF tower instead of a DAF tank in certain applications, the present disclosure expressly contemplates the use of a DAF tank instead of a FF tower as well as other systems, devices, and methods for separating solids from wastewater. As such, the present disclosure is not limited to wastewater treatment systems and methods using only a FF tower, but rather, includes any other device, system, or method now known or developed in the future for separating solids from wastewater.

After separation in the foam fractionation tower or reservoir 236, the treated liquid fraction, or the wastewater with the solids separated therefrom, which may also be referred to as the wastewater effluent, is discharged from the fractionator 236 along line 244 to a fine screen 246 for removing any remaining particulate solids. The effluent then flows through an ultraviolet processing unit 248, which destroys any residues of chemical oxidants such as peracetic acid if it is added in the floc tube 222 with light in the ultraviolet spectrum. The ultraviolet processing unit 248 acts as a failsafe for disinfection. In certain embodiments, the screen 246 and the ultraviolet processing unit 248 are not included in the system 200, as the same are not necessary to provide effluent of sufficient quality and composition. Finally, after exiting the ultraviolet processing unit 248, the effluent flows to a treated wastewater discharge 250, which may be an existing effluent outfall into a body of water, for example.

The recovered solids or foamate produced by the fractionator 236 flows from the fractionator 236 into a sludge tank 252 along line 254. The solids can be thickened (e.g., any residual water removed from the solids) through gravity separation or by adjusting the pH and adding chitosan, a natural flocculant. Thickening of the solids produces decantate, which collects at a bottom or base of the sludge tank 252. The decantate is drained back to the wastewater sump 204 for additional processing, as above, via line 256. The decanted solids remaining in the sludge tank 252 are then pumped with pump 258 along line 260 to a transport bin for recycling the recovered solids offsite.

In some embodiments, the solids and/or foamate from the fractionator 236 are first received at foamate tank 253 along line 254 before passing to the sludge tank 252. The foamate tank 253 is configured to break down the foamate to a liquid containing particulate organic matter. For example, in some embodiments, the foamate tank 253 includes a motor with a blade, wherein the motor rotates the blade to break down the foamate into water or into a foam and water combination. As such, the foamate tank 253 reduces the volume of foamate transported through system 200. In some embodiments, the blade can be a large knife type blade, an auger, a paddle, a mixing paddle, a propeller, or any other type of rotary blade. In one or more embodiments, one or more additives are added to foamate tank 253 to further reduce foam content, although the same is not required.

In the industry, the motor and blade combination may be referred to as a “foam buster.” As such, the foamate tank 253 includes a foam buster in the foamate tank 253, in some embodiments. In one or more embodiments, the foam buster may be located in an external location in fluid communication with the foamate tank 253, preferably upstream of the foamate tank 253 along line 254. The broken down solids and foamate in the foamate tank 253 are then pumped from the foamate tank 253 along line 257 by pump 255 to sludge tank 252. For clarity, line 257 includes the line connecting foamate tank 253 to pump 255 and connecting pump 255 to sludge tank 252. In some embodiments, the foamate tank 253 and pump 255 are omitted and the foamate and solids are sent directly to sludge tank 252 along line 254.

In some embodiments, processing the wastewater 202 with system 200 produces decantate at sludge tank 252 that is sufficiently clear of harmful oils, fats, bacteria, and viruses such that the decantate can be discharged without further processing. As such, the decantate can be pumped from sludge tank 252 to line 244 via line 257. The decantate then passes through fine screen 246 and the UV system 248 before being discharged at 250. In other embodiments, the decantate is sent via line 257 directly to an outfall without further processing by the screen 246 and UV system 248. In one or more embodiments, the system 200 does not include fine screen 246, but rather, decantate is sent directly to UV system 248.

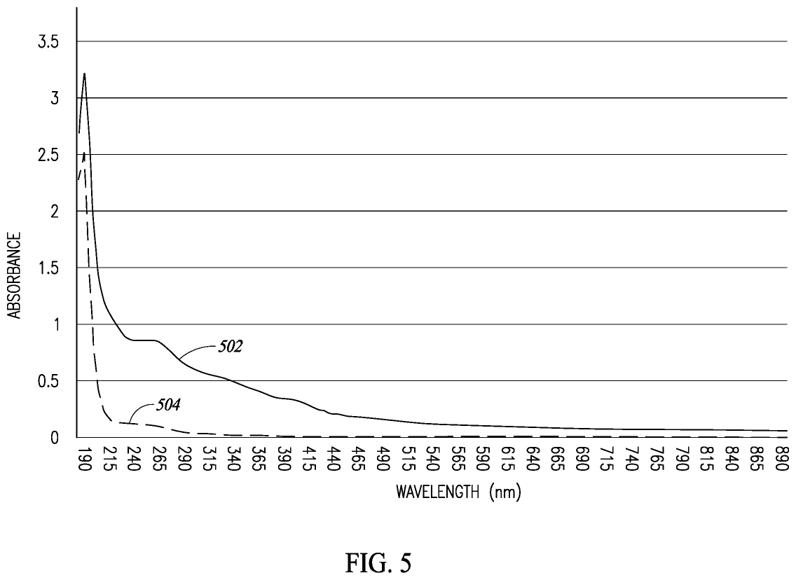

The above system 200 can significantly reduce the content of organic material in wastewater, as described below with reference to FIGS. 5-7. It is believed that reduction in organic material includes reduction in bacterial and viral content is the result of one or more of the following: (i) adding ferric sulfate or peracetic acid, or both, to the wastewater before storage in the equalization tanks; (ii) coagulating and flocculating the solids with the FF tower, whereby viruses and bacteria are removed with the solids; (iii) adding ozone to the FF tower; and (iv) passing the wastewater through the UV disinfectant system.

As such, an embodiment of a method for treating wastewater utilizing system 200 includes pretreating the wastewater 202 with the floc tube 226 and at least one chemical pump (e.g., at least one of chemical pumps 228, 230, 232, or in other embodiments, by manual addition or some other form of addition). In an embodiment, the pretreating includes adding ferric sulfate to the wastewater 202 to form a pretreated wastewater mixture in the floc tube 226. Then, the method continues by pumping, via feed pump 222, the pretreated wastewater mixture into a foam fractionation tower 236. In an embodiment, the foam fractionation tower 236 is operated to separate the pretreated wastewater into a foamate and a remaining effluent within the tower 236, as described above. The method may then terminate by discharging the effluent and the foamate along separate flow paths for further processing, as above.

In further embodiments of the method, pretreating the wastewater includes, after adding the ferric sulfate, adding peracetic acid to the wastewater 202 to form the pretreated wastewater mixture, wherein adding the peracetic acid may include the second chemical pump 230, or some other method of addition, including manually. Adding at least one of, or potentially both, of the ferric sulfate and the peracetic acid lowers a pH of the pretreated wastewater mixture to a level at or below an isoelectric point of the wastewater 202. Then, in various embodiments, before pumping the pretreated wastewater mixture into the foam fractionation tower 236, sodium hydroxide is added to the pretreated wastewater mixture (e.g., after adding ferric sulfate and peracetic acid, in an embodiment), wherein adding the sodium hydroxide includes raising the pH of the pretreated wastewater mixture. Preferably, the resulting pH of the pretreated wastewater mixture is between 6.5 and 7.5, although in other embodiments, the resulting pH may be different based on the concentration of chemicals in the pretreated wastewater following pretreatment.

In yet further embodiments, the pumping the pretreated wastewater mixture into the foam fractionation tower 236 includes feeding the pretreated wastewater mixture into the foam fractionation tower 236 proximate a first end of the foam fractionation tower opposite a base of the foam fractionation tower. In an embodiment where the tower 236 is vertical, the first end may be an upper or top end, and the base may be a lower or bottom end, as described below with reference to FIG. 4. Preferably, the tower 236 is operated countercurrently, such that the wastewater 202 is added to the tower 236 in a direction opposite to a direction of a current flow within the tower 236 (e.g., in an embodiment, wastewater 202 is added in a downward direction against the vertical current of the foam and liquid in the tower 236).

Additional processing of the effluent remaining in the tower 236 can include discharging the effluent proximate the base of the foam fractionation tower 236 and flowing the effluent through at least one of a mesh screen or an ultraviolet treatment system to provide a refined effluent. Preferably, the effluent is flowed through both a mesh screen and the ultraviolet treatment system, although the same is not necessarily required. Finally, the effluent can be discharged to an existing wastewater discharge, or some other downstream receiving source, such as a wastewater treatment plant.

Additional processing of the foamate from the tower 236 includes discharging the foamate from the first end of the foam fractionation tower 236 opposite the base, preferably to the sludge tank 252, although other embodiments include discharging the foamate directly to some other receiving source, such as a landfill, or a fertilizer or compost processing plant. In embodiments where the foamate is received in the sludge tank 252, the method further includes, after the discharging the foamate, dewatering the foamate. Dewatering the foamate can include, in various alternative embodiments, separating water from the foamate by gravity separation in a sludge tank or by adjusting a pH of the foamate and adding chitosan to the foamate. Chitosan is a natural flocculant that results in additional dewatering of the solids by causing colloids and other suspended particles in liquids to aggregate, forming a floc that is separate from the remaining wastewater decantate. As above, in an embodiment, the decantate may be returned to the sump 204 for reintroduction to the system 200, thus creating a fluid loop within the system 200. In some embodiments, the decantate is sent directly to the outfall via the ultraviolet processing unit 248, as above.

FIG. 3 illustrates an embodiment of a chemical pretreatment system 300 described above with reference to the system 200 in FIG. 2. The chemical pretreatment system 300 includes a feed pump 302 in fluid communication with at least one equalization tank 304 and a floc tube 306. As illustrated, the feed pump 302, the equalization tank 304, and the floc tube 306 define a flow path for wastewater stored in the tank 304, from the tank 304 to the pump 302 along line 308 from an outlet 310 of the tank 304 to an inlet 312 of the pump 302. In other words, the equalization tank 304 is upstream of the pump 302 along the flow path through the system 300, such that during operation, the equalization tank 304 provides wastewater stored in the tank to the inlet 312 of the pump 302. A second equalization tank 305 is illustrated in dashed or broken lines and fluidly connected in series with the equalization tank 304 to indicate that in some embodiments, the second tank 305, or further additional tanks, may or may not be required, but are expressly contemplated by the present disclosure.

The floc tube 306 is fluidly connected to an outlet 314 of the pump 302 and is preferably downstream from the pump 302, such that the floc tube 306 receives wastewater output from the pump 302 via the equalization tank 304. As illustrated, the floc tube 306 includes a plurality of tubes or pipes 316 arranged in a serpentine and overlapping arrangement, such that flow along the floc tube 306 is tortuous, which provides mixing of the wastewater as it moves through the floc tube 306. Although the floc tube 306 is illustrated as having three pipes or tubes 316, it is to be appreciated that in practice, the floc tube 306 may include significantly more (e.g., more than 10 total pipes or tubes), or potentially less, than the number of tubes 316 illustrated. It is to be appreciated that in alternative embodiments, one or more mixing tanks may be substituted for the floc tube 306 along the flow path through system 300, wherein the mixing tanks provide mixing of the wastewater and added chemicals, rather than the floc tube 306.

FIG. 3 further illustrates that the system 300 includes at least one chemical pump 318 fluidly connected with the flow path downstream of the pump 302. In an embodiment, the at least one chemical pump 318 includes at least three chemical pumps, including a first chemical pump 318, a second chemical pump 320, and a third chemical pump 322 arranged in sequential order and spaced along the flow path. It is to be appreciated that the chemical pumps 318, 320, 322 can be arranged anywhere along the flow path, including along various locations of the floc tube 306, both upstream of the floc tube 306 and downstream of the pump 302, or even downstream of the floc tube 306. Further, each of the chemical pumps 318, 320, 322 are illustrated as being connected into the flow path with a valve 324, which has been shown in dashed or broken lines to indicate that it may be included in some embodiments, and excluded from others, depending on whether it is desirable to control, separate from control of the pumps 318, 320, 322, the addition of chemicals into the wastewater. It is to be appreciated that the system 300, as well other systems and methods described herein, may use various valves, fittings, and other fluid coupling or control devices that have not described simply for purposes of clarity to avoid obscuring the features of the preferred embodiments.

In an embodiment, the first chemical pump 318 provides ferric sulfate to wastewater from the feed pump 302, the second chemical pump 320 provides peracetic acid to the wastewater, and the third chemical pump 322 provides sodium hydroxide to the wastewater, in sequential order, with spacing amongst the chemical pumps 318, 320, 322 allowing for mixing and equalization of the wastewater prior to further chemical addition. In other embodiments, the chemicals are added in different order, or all at the same time. As a result, the wastewater exiting the floc tube 306 along line 326 fluidly connected to a last or final one of the plurality of tubes 316 is chemically pretreated wastewater that is provided to a foam fractionation system described with reference to FIG. 4.

FIG. 4 illustrates an embodiment of a foam fractionation system 400 that receives the chemically pretreated wastewater from the pretreatment system 300. In other words, the foam fractionation system 400 is in fluid communication with the pretreatment system 300 and is preferably downstream from the pretreatment system 300 within a broader processing system, such as system 200. The foam fractionation system includes a reservoir 402 having a fluid inlet 404 through which wastewater, and preferably chemically pretreated wastewater is received, a fluid outlet 406 for discharging effluent, and a foamate outlet 408 for discharging foamate. The reservoir 402 further includes a first end 410, which in an embodiment, is a lower or bottom end, and a second end 412 opposite the first end 410, which in an embodiment, is an upper or top end.

A gas injection pump 414 is in fluid communication with the reservoir 402 through a fluid loop including lines 420 and 422 between the gas injection pump 414 and the reservoir 402. Specifically, the line 420 is fluidly coupled between the pump 414 and a recirculation outlet 416 proximate the first end of the reservoir 402. Wastewater near the first end 410 of the reservoir 402 is drawn into the gas injection pump 414 along line 420. The gas injection pump 414 then injects gas into the wastewater, and pumps the gas injected wastewater to a gas inlet 418 in the first end 410 of the reservoir 402 along line 422, thus creating a fluid loop between the reservoir 402 proximate the first end 410 and the gas injection pump 414.

A gas source 424 is upstream of the gas injection pump 414 and provides gas along line 428 to the pump 414 for injection into the wastewater. In an embodiment, the gas source 424 is an ozone generator, or an ozone tank. In an alternative embodiment, the gas source 424 is an air source 426, which is connected to line 428 by a valve 430, wherein the air source 426 may be any one of a compressor, an air tank, or a one way valve that provides air to the pump due to the negative pressure differential generated by the pump along line 428, for example. In yet further embodiments, the gas source 424 generally includes both an ozone generator 424 and an air source 426, wherein both air and ozone are provided as gas for injection in the wastewater. In still further embodiments, other gases and respective gas generators may be used as the gas source 424.

The system 400 further includes a flow outlet path 432 in fluid communication with the fluid outlet 406 of the reservoir 402. A screen 434 is in the flow outlet path 432 downstream from the reservoir 402, wherein during operation, the screen receives effluent flowing from the fluid outlet 406 of the reservoir 402 and removes any residual fine particulate matter in the effluent. An ultraviolet treatment system 436 is in fluid communication with the screen 434 downstream from the screen 434 along flow outlet path 432. The ultraviolet treatment system 436 receives effluent from the screen 434 and uses light in the ultraviolet spectrum to destroy bacteria and viruses present in the effluent before discharge from the system 400.

The foamate outlet 408 is in fluid communication with a sludge tank 438 downstream from the reservoir 402 along line 440. The sludge tank 438 receives foamate from the foamate outlet 408 following operation of the system 400, as described above. The sludge tank 438 stores the foamate to enable dewatering before further downstream processing. For example, dewatering can occur through gravity separation or by adjusting the pH of the foamate and adding chitosan. In some embodiments, the foam fractionation system 400 includes a foamate tank 437 upstream from the sludge tank 438 along line 440. The foamate tank 437 may be a barrel or other reservoir including a foam buster, as described herein, for reducing a volume of the foamate by breaking down the foam in the foamate. The broken down foamate and solids are then provided from foamate tank 437 to sludge tank 438 along line 439 for storage and dewatering in the sludge tank 438, as described herein. In some embodiments, a pump is positioned along line 439 for pumping the broken down foamate and solid mixture from the foamate tank 437 to the sludge tank 438, similar to pump 255 in FIG. 2.

The dewatered solids are then collected and pumped out of the sludge tank 438 by a pump 442 along line 444 and sent to a landfill, a fertilizer processing plant, a compost processing plant, or some other destination. A decantate line 446 is in fluid communication with the sludge tank 438 and a sump 448 for providing decantate (e.g., wastewater remaining after dewatering the foamate in the sludge tank 438) to the sump 448. As described with reference to FIG. 2, the sump 448 may be in fluid communication with a sump pump, a rotary screen, and one or more equalization tanks in order to establish a fluid loop within a broader system. Further, in some embodiments, decantate can be provided from sludge tank 438 to line 432 via line 433, wherein the decantate is processed through screen 434 and UV treatment system 436 before being discharged, as described with reference to FIG. 2.

### Experimental Test Results

The following data and experimental test results further illustrates the embodiments of the present invention and is not to be construed as limiting the present disclosure in any manner. Field trials were conducted at a farmed salmon processing plant. Samples of wastewater were collected to evaluate the wastewater and to test the most effective chemical treatment options. Foam fraction tests were conducted on a batch basis on bench top using a plastic settleometer, an aquarium air pump, and a ceramic sparging stone. Small scale piloting was done using a Foam Fractionator operating in concurrent mode and on a batch basis. Gas, such as air and ozone, was added by adding a Mazzei injector to the feed line to the Foam Fractionator.

Chemical pretreatment before foam fractionation on a pilot scale was accomplished by pumping the wastewater through a full-scale floc tube with chemical injection pumps. Wastewater exiting the Floc Tube was diverted to a feed tote for the foam fractionator. A submersible pump was used to recirculate the wastewater through the Foam Fractionator for about 10-15 minutes or when the wastewater turned clear, which, in some cases, was more or less than 10-15 minutes. Samples were collected onsite and tested for total solids, salinity, pH, UV transmittance. Samples were further subjected to a multiwave length scan using a UV-VIS spectrophotometer. Some samples of the raw or untreated wastewater and the treated wastewater were sent to an outside lab for analysis.

The volume of foamate and treated wastewater were collected and measured volumetrically. The solids content was measured using standard methods. A mass balance was done to validate the data based on known quantities of the volume and solids content of the feed, foamate, and treated wastewater.

Table I below represents the parameters and lab results for a first experimental run, wherein the results of the spectrophotometer testing are displayed in graphical form in corresponding FIG. 5. FIG. 5 represents multiwave scans for the wastewater before and after treatment according to the parameters specified in Table I. The y-axis represents UV absorbance and the x-axis is wavelength, in nanometers, wherein line 502 corresponds to raw wastewater before treatment, and line 504 corresponds to wastewater after treatment as in Table 1.

TABLE 1
Run #1

| | | Chemical Dosing | | | | |
|---|---|---|---|---|---|---|
| | | Ferric | Peracetic | | After Chem addition | |
| Raw Wastewater | | Sulfate, | Acid, | Caustic, | | Ozone |
| Salinity, ppt | % UVT | ppm | ppm | ppm | pH | Addition |
| 15.11 | 14.06 | 1,223 | 0 | 1,008 | 6.6 | Yes |
| Liquid Fraction, | 77.98 | | | | | |
| % UVT | | | | | | |
| Foamate: | 11.8 | liters | | | | |
| Liquid Fraction: | 44.01 | liters | | | | |
| Total: | 55.81 | liters | | | | |
| Foamate % volume | 21% | | | | | |

Outside Lab Results

| | FF Feed | FF Effluent | % diff | Log Reduction |
|---|---|---|---|---|
| Nitrite (N), mg/L | 0.012 | ND | −100% | |
| Nitrate (N), mg/L | 0.062 | 0.138 | 123% | |
| Organic Nitrogen(N), | 92.8 | 12 | −87% | |
| mg/L | | | | |
| TKN [Calc.], mg/L | 98.6 | 17.7 | −82% | |
| BOD, mg/L | 426 | 83.9 | −80% | |
| CBOD, mg/L | 388 | 81.9 | −79% | |
| COD, mg/L | 1,090 | 381 | −65% | |
| Salinity, g/L | 15.5 | 15.9 | 3% | |
| Ammonia (N), mg/L | 5.8 | 5.7 | −2% | |
| Oil & Grease, mg/L | 14 | ND | −100% | |
| pH | 6.25 | 6.97 | | |
| TSS, mg/L | 926 | 33.6 | −96% | |
| E. coli, CFU/100 mL | ND | ND | | |
| Enterococcus spp., | 35,000 | 32 | −99.9% | 3.04 |
| CFU/100 mL | | | | |
| Total Coliforms, | 82,000 | 64 | −99.9% | 3.11 |
| CFU/100 mL | | | | |

This experimental run was based on a higher dosing of ferric sulfate with no addition of peracetic acid. The foamate was 21% of the wastewater volume. Based on subsequent trials, this results appears to have been caused by using a commercially available vacuum to extract the foamate, as the foamate was allowed to dewater excessively in the foam fractionation tower. Regarding the liquid fraction discharged from the foam fractionation tower, the lab results indicate a significant reduction in pollutants and organisms with the exception of nitrate. However, the nitrate value is acceptably small and the increase is likely due to the oxidation of nitrogenous compounds. The % UVT improved over 5 fold, wherein the % UVT is related to the clarity and purity of the liquid fraction.

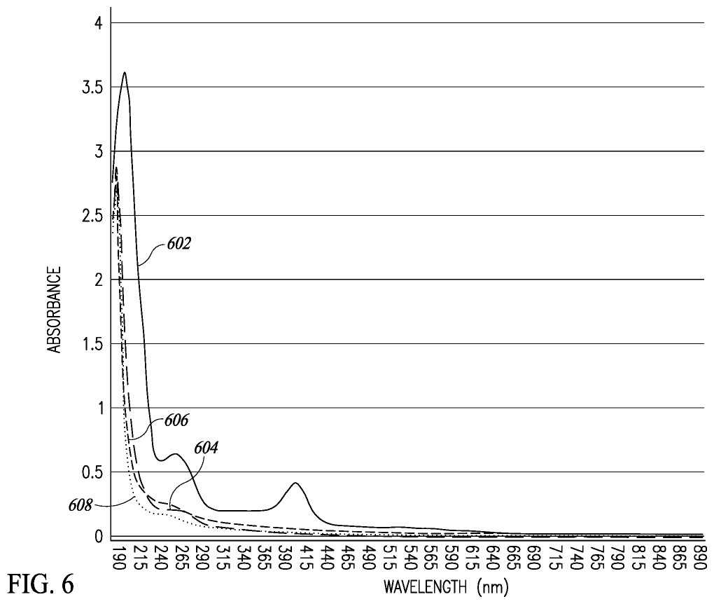

In a second experimental test, four samples were analyzed: the raw wastewater, the raw wastewater after chemical addition (and allowed to settle), and the liquid fraction from the foam fractionation tower for two runs. Once again there was a significant reduction in UV absorbing compounds. It is interesting to note that Run #4 was run with ferric sulfate at 481 ppm versus 1,069 ppm for Run #5. The higher ferric dose with foam fractionation performed the best, followed by the lower ferric dose and foam fractionation, followed by chemical treatment only and settling. Table II summarizes the parameters and test results for Runs #4 and #5 and FIG. 6 is as graphical representation of multiwave scans for the various samples according to the above and the treatment parameters specified in Table 2.

TABLE 2
Run #4

| | | Chemical Dosing | | | | | |
|---|---|---|---|---|---|---|---|
| | | Ferric | Peracetic | | After Chem addition | | |
| Raw Wastewater | | Sultate, | Acid, | Caustic, | | Ozone | |
| Salinity, ppt | % UVT | ppm | ppm | ppm | pH | Addition | Reflux |
| 13.26 | 24.95 | 481 | 6 | 397 | 6.54 | Yes | Yes |
| Liquid Fraction, | 56.11 | | | | | | |
| % UVT | | | | | | | |
| Foamate: | 18.1 | liters | | | | | |
| Liquid Fraction: | 47.91 | liters | | | | | |
| Total: | 66.01 | liters | | | | | |
| Foamate % | 27% | | | | | | |
| volume | | | | | | | |

| | Outside Lab Results | | | In House Lab Results | | |
|---|---|---|---|---|---|---|
| | TS, mg/l | TS, gm | | TS, mg/l | TS, gm | |
| Foamate: | 15,400 | 278.74 | | 15,963 | 288.93 | |
| Liquid Fraction: | 13,000 | 622.83 | 901.57 | 14,237 | 682.09 | 971.02 |
| FF Feed: | 15,400 | 1,016.55 | −11% | 15,400 | 1,016.55 | −4% |

Run #5

| | | Chemical Dosing | | | | | |
|---|---|---|---|---|---|---|---|
| | | Ferric | Peracetic | | After Chem addition | | |
| Raw Wastewater | | Sultate, | Acid, | Caustic, | | Ozone | |
| Salinity, opt | % UVT | ppm | ppm | ppm | pH | Addition | Reflux |
| 13.26 | 24.95 | 1,069 | 6 | 992 | 6.54 | Yes | Yes |
| Liquid Fraction, | 68.23 | | | | | | |
| % UVT | | | | | | | |
| Foamate: | 6 | liters | | | | | |
| Liquid Fraction: | 63.71 | liters | | | | | |
| Total: | 69.71 | liters | | | | | |
| Foamate % | 8.6% | | | | | | |
| volume | | | | | | | |

| | Outside Lab Results | | | In House Lab Results | | |
|---|---|---|---|---|---|---|
| | TS, mg/l | TS, gm | | TS, mg/l | TS, gm | |
| Foamate: | 21,600 | 129.60 | | 18,410 | 110.46 | |
| Liquid Fraction: | 15,100 | 962.02 | 1,091.62 | 14,330 | 912.96 | 1,023.42 |
| FF Feed: | 14,900 | 1,038.68 | 5% | 14,900 | 1,038.68 | −1% |

The foamate for Run #4 was extracted using a commercially available vacuum, resulting in the foamate being 27% of the wastewater volume. In order to validate this number, a mass balance was done on the total solids entering and exiting the foam fractionator. Using the in-house total solids measurements, the mass balance reconciled to −4% difference between what entered and exited the foam fractionator.

For Run #5, the vacuum was not used and the top cover for the foam fractionator was bolted back on. The foamate rose to the top of the unit and exited through a drain line. The foam fractionator was adjusted for wetter foam but the overall result was a reduction in foamate volume to 8.6% of the wastewater volume. The solids mass balance reconciled to −1%. Based on the % UVT of the liquid fraction, reducing the foamate volume did not adversely affect the performance, although Run #5 was conducted using almost double the dose of ferric sulfate compared to Run #4.

In FIG. 6, the y-axis represents UV absorbance and the x-axis is wavelength, in nanometers. Line 602 corresponds to UV absorbance of raw wastewater, line 604 corresponds to UV absorbance after chemical pretreatment and settling, line 606 corresponds to Run #4 treated liquid fraction, and line 608 corresponds to Run #5 treated liquid fraction.

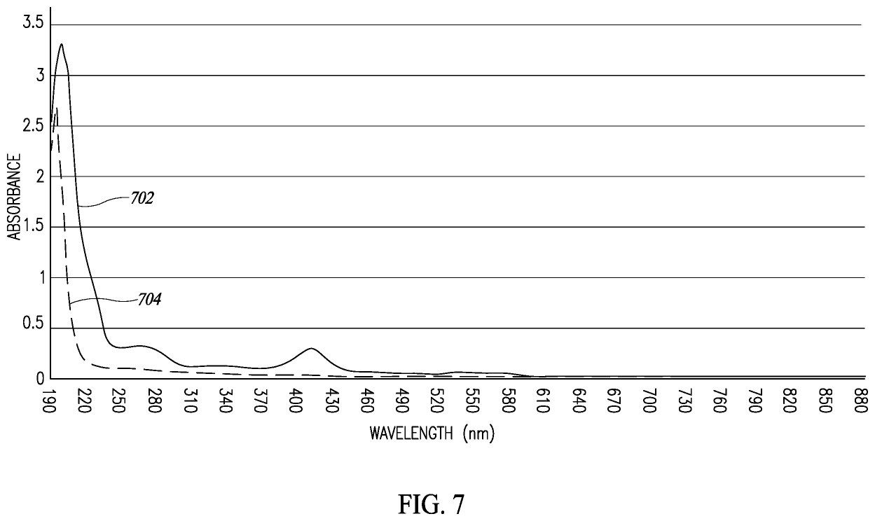

In a third experimental test, a full scale system, such as system 200 described herein, was used to process wastewater at a farmed salmon processing plant. Samples of the untreated and treated wastewater from the system were analyzed in an accredited lab. The wastewater feed rate was 55 gallons per minute. The pollutant reductions were as high as 91% for biochemical oxygen demand, 95% for total suspended solids, 41% for ammonia-nitrogen, 100% for oil and grease, 85% for total Kjeldahl nitrogen, and 100% for Enterococcus bacteria. The influent and effluent waters were tested using a Hach DR 6000 UV-Vis spectrophotometer, with the results shown in FIG. 7.

In FIG. 7, the y-axis values are absorbance, as in FIGS. 5 and 6, and the x-axis values are wavelength in nanometers. Line 702 represents the influent UV absorbance and line 704 represents the effluent UV absorbance. The system increased the percentage ultraviolet transmittance from 49.8% for the influent to 80.9% for the effluent. UV cleaning or disinfectant systems each have a different design capacity of UV transmittance in order to allow for effective operation. In other words, different UV systems may be able to operate and clean wastewater with at least 25% UV transmittance, at least 50% UV transmittance, or at least 65% UV transmittance in some embodiments. In general, UV systems that are able to operate with lower UV transmittance (e.g., operate to clean dirtier wastewater with higher UV absorbance because of increased organic matter content in the water) have a considerably higher price. As such, the increase in UV transmittance from 49.8% to 80.9% from treatment of wastewater with embodiments of the present disclosure allows for processing of the effluent with a cheaper UV system. For example, in some embodiments, the UV systems described herein are designed to operate with wastewater of at least 65% UV transmittance. As such, wastewater effluent with an 80.9% UV transmittance is considerably greater than the operational capacity of the UV systems described herein.

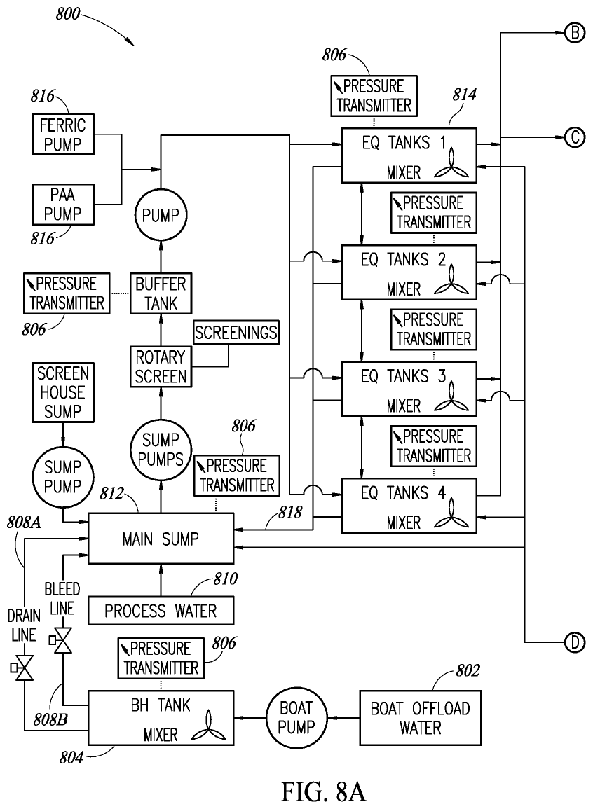

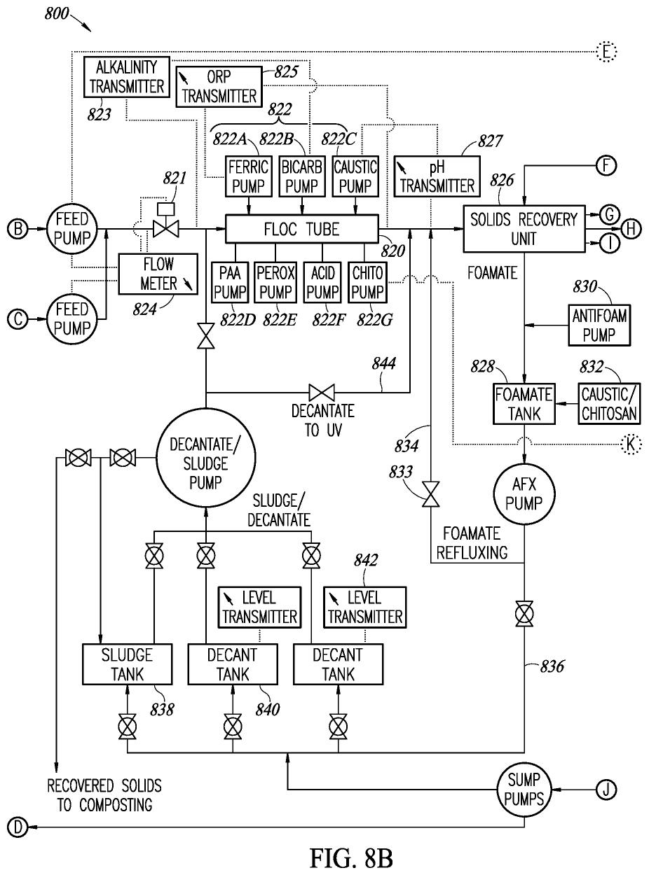

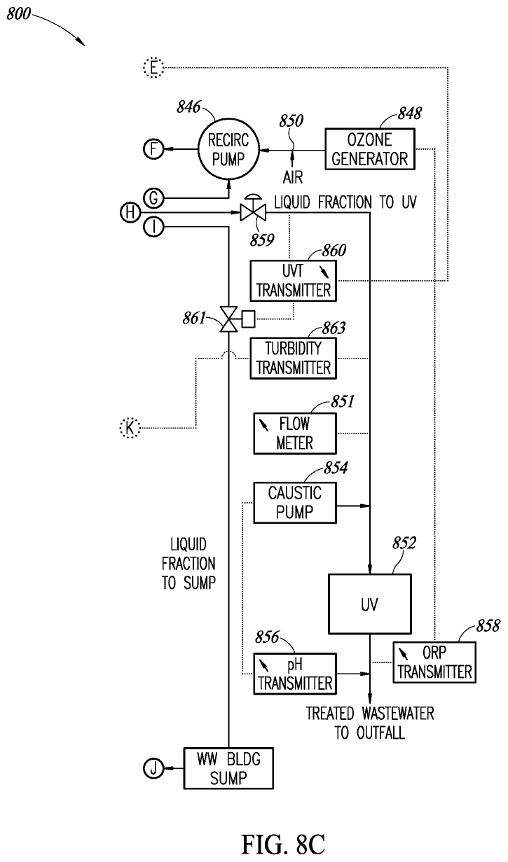

In some embodiments, the wastewater influent may have different characteristics that utilize different processing times and techniques to achieve the results discussed above. FIGS. 8A-8C are schematic views of an embodiment of a system 800 for processing wastewater that includes the pretreatment chemicals added to the system 800 at different locations in the process flow, among other differences, relative to the systems described herein. Unless the context clearly dictates otherwise, the solid lines in FIGS. 8A-8C are process flow lines representing a fluid flow path through the system 800 and the dotted or dashed lines are control lines that represent electronic communication lines for controlling characteristics or parameters of the fluid flow through the system 800. The system 800 enables a wider array of processing methods and steps, as explained in more detail below. The system 800 may be identical to the systems described herein except as other provided and thus repetitive description is omitted in the interest of efficiency and to avoid obscuring embodiments of the disclosure. Further, it is to be appreciated that although FIGS. 8A-8C illustrate only certain sections or portions of a larger schematic of the system 800, that the components in FIGS. 8A-8C are interconnected and in fluid communication with each other to form the system 800. Thus, the system 800 is shown in combination with reference to FIGS. 8A-8C.

Beginning with FIG. 8A, the system 800 includes an influent of wastewater 802 that is pumped to a tank mixer 804 by a boat pump. Although FIGS. 8A-8C describe an example using fish wastewater from a boat, such as in a farmed salmon processing operation, the influent wastewater 802 may be any of the types of wastewater described herein. The tank mixer 804 includes one or more devices or systems for mixing the influent wastewater 802, such as an auger, paddle, or a mixer blade in some non-limiting examples. In some embodiments, a pressure transmitter 806 is in communication with the tank mixer 804 to measure and report a pressure or flow rate of the influent wastewater 802, or the effluent from the tank mixer 804, or the pressure in the tank mixer 804, or any combination thereof. In some embodiments, the pressure transmitter 806 is a single variable transmitter (i.e., to measure only one characteristic, such as pressure) or a multivariable transmitter (i.e., to measure multiple characteristics, such as differential pressure, static pressure, and temperature with a single device). The pressure transmitter 806 may also be a pressure transducer or a pressure sensor.

The pressure transmitter 806 may be coupled directly to the tank mixer 804 and be in electronic communication, either through a wired connection or a wireless connection, to a controller for the system 800. The controller may be part of the system 800 or may be located external to the system 800, such as a mobile device or laptop in electronic communication with components of the system 800. In embodiments where the pressure transmitter 806 is a wireless device, the pressure transmitter 806 and the controller may each include one or more hardware components such as a memory, a processor, an antenna, a receiver, or a transceiver structured execute instructions to communicate over any known communication protocol, such as Wi-Fi® or Bluetooth®, among others. Additionally or alternatively, the pressure transmitter 806 may include a display screen that is read manually by an operator of the system 800.

Effluent from the tank mixer 804 passes through a drain line 808A and a bleed line 808B, which may include one or more valves, for controlling the rate of effluent from the tank mixer 804. Where the pressure transmitter 806 detects that the pressure in the tank mixer 804 or the pressure of the influent wastewater 802 exceeds a selected threshold, the valves in the lines 808A, 808B can be adjusted in response to increase the effluent flow rate from the tank mixer 804 and alleviate the pressure concerns at the tank mixer 804. Alternatively, if the pressure detected at the tank mixer 804 by the transmitter 806 is too far below a selected threshold pressure, then the valves in the lines 808A, 808B can be adjusted to reduce the effluent from the tank mixer 804, or the flow rate of the influent wastewater 802 can be increased, such as by adjusting the flow rate of the pump, or any combination thereof. The other pressure transmitters described herein may have a similar function and provide an indication of flow rate adjustments in the system 800, unless the context clearly dictates otherwise.

The effluent from the tank mixer 804 proceeds through lines 808A, 808B and joins process water 810 at the main sump 812. The wastewater is pumped from the main sump 812 to a rotary screen and buffer tank, as described herein. In some embodiments, there is a fluid loop between the rotary screen and the main sump 812 to return solid matter containing wastewater liquid that passes through the screen back to the main sump 812 for additional screening and processing (i.e., Screen House Sump and Sump Pump in fluid communication with main sump 812). The wastewater is pumped from the buffer tank after initial screening to equalization (“EQ”) tanks 814. The wastewater may be allowed to settle in the EQ tanks 814 for a selected period of time to separate solid material from liquid matter, as described herein. Further, although FIG. 8A illustrates four EQ tanks 814, the number of EQ tanks may also be selected to be more or less than four tanks 314 depending on the flow volume and rate processed by the system 800.

Each of the EQ tanks 814 may include a mixer or agitator of any of the types described herein, in some embodiments. Further, each EQ tank 814 may be associated with a pressure transmitter 806 to provide an indication of the pressure in the system 800 at each EQ tank 814 to enable corresponding adjustments, as described above. In some embodiments, there are no pressure transmitters 806 at the EQ tanks 814, or there may be a pressure transmitter 806 associated with only select ones of the EQ tanks 814, such as the first EQ tank 814 and the last EQ tank 814 in the series in one non-limiting example. Upstream of the EQ tanks 814 and in fluid communication with the EQ tanks 814 is one or more first chemical pumps 816. In a preferred embodiment shown in FIG. 8A, there are two first chemical pumps 816 downstream of the buffer tank and upstream of the EQ tanks 814. The first chemical pumps 816 are in fluid communication with the EQ tanks 814 to provide pretreatment chemicals to the EQ tanks 814, as described herein. In particular, the system 800 includes a pump in fluid communication with, and directly downstream, from the buffer tank with the pump also being directly upstream from the EQ tanks 814 in some embodiments (i.e., the pump is between the buffer tank and the EQ tanks 814 to pump wastewater from the buffer tank to the EQ tanks 814). The first chemical pumps 816 may add chemicals to wastewater in the system 800 between the pump and the EQ tanks 814, as shown in FIG. 8A.

The one or more first pumps 816 may supply any of the chemical compounds described herein in a selected quantity, volume, or concentration, or any combination thereof, to the wastewater before the wastewater is stored in the EQ tanks 814. In a preferred embodiment, the first pumps 816 provide ferric sulfate and peracetic acid to the wastewater upstream of the EQ tanks 814. The ferric sulfate and peracetic acid may be introduced via the first chemical pumps 816 in any order, such as adding the ferric sulfate first, last, or at the same time as the peracetic acid relative to the flow direction through the system 800. Further, although the first pumps 816 are illustrated as being between the buffer tank and the EQ tanks 814, the first pumps 816 may also be positioned anywhere upstream of this location. In some non-limiting examples, the first pumps 816 may be in fluid communication directly with one or more of the buffer tank, the main sump, the tank mixer 804, or any other location upstream of the EQ tanks 814 in the illustrated schematic of FIG. 8A.

The benefits of treatment of the wastewater with chemicals before residence in the EQ tanks 814 will be described in greater detail below with reference to the example methods of operation of the system 800. In one or more embodiments, the liquids or solids, or both, from the EQ tanks 814 are drained by gravity back to the main sump along line 818 for further processing in the system 800.

Turning to FIG. 8B, the liquid from the EQ tanks 814 is pumped to a floc tube 820 along line B-B and line C-C in FIG. 8A and FIG. 8B. The floc tube 820 may function similarly to the other floc tubes described herein. One or more second chemical pumps 822 are in fluid communication with the floc tube 820 for adding any of the chemical compounds described herein in any selected quantity, volume, or concentration to the wastewater in the floc tube 820. In a preferred embodiment, one chemical pump 822A of the second chemical pumps 822 introduces ferric sulfate to the wastewater in the floc tube 820, a second chemical pump 822B of the second chemical pumps 822 introduces sodium bicarbonate to the wastewater in the floc tube 820, a third chemical pump 822C of the second chemical pumps 822 introduces a caustic agent to the wastewater in the floc tube 820, a fourth chemical pump 822D of the second chemical pumps 822 introduces peracetic acid to the wastewater in the floc tube 820, a fifth chemical pump 822E of the second chemical pumps 822 introduces hydrogen peroxide to the wastewater in the floc tube 820, a sixth chemical pump 822F of the second chemical pumps 822 introduces a selected acid, such as citric acid in a non-limiting example, to the wastewater in the floc tube 820, and a seventh chemical pump 822G of the second chemical pumps 822 introduces chitosan to the wastewater in the floc tube 820. The caustic agent may be sodium hydroxide or calcium hydroxide, and the acidic agent may be sulfuric acid in some preferred embodiments, although the present disclosure contemplates the use of additional caustic agents.

In an embodiment, the first chemical pumps 816 may include any of the above referenced second chemical pumps 822. The second chemical pumps 822 may be arranged in any order along the floc tube 822, such as the first chemical pump 822A being first, in the middle, or last relative to the other chemical pumps 822B, 822C, 822D, 822E, 822F, 822G in the second chemical pumps 822. In some embodiments, one or more flow meters 824 are in communication with one or more feed pumps upstream of the floc tube 820 that pump the wastewater from the EQ tanks 814 to the floc tube 820. The flow meters 824 may measure a rate of flow from the pumps to the floc tube 820 to enable a corresponding adjustment in the chemical quantity, volume, or concentration introduced at the floc tube 820 by the second chemical pumps 822. The flow meters 824 may also enable an adjustment of the flow rate through the floc tube 820 via flow control valve 821 that is in communication with the flow meters 824. The flow control valve 821 is in fluid communication with the feed pumps and the floc tube 820 with the valve 821 downstream of the feed pumps and upstream of the floc tube 820. In some embodiments, the valve 821 controls the flow rate through the floc tube 820 based, at least in part, on the measured flow from the flow meter 824.

In an embodiment, the system 800 further includes a system and process for determining and modulating the pretreatment chemicals (i.e., the chemical mixture introduced via first chemical pumps 816 and second chemical pumps 822) added to the wastewater to achieve consistently and continuously cleaner effluent. The system 800 may include an alkalinity transmitter 823 in communication with the flow from the feed pumps upstream of the floc tube 820 (i.e., in communication with the influent to the floc tube 820) and in communication with the bicarbonate pump 822B (as well as any of the other second chemical pumps 822). The alkalinity transmitter 823 measures the incoming wastewater and automatically modulates the bicarbonate introduced by the bicarbonate pump 822B to maintain a selected target alkalinity value.

In addition, the system 800 may include an Oxidation Reduction Potential (“ORP”) transmitter 825 in communication with the second chemical pumps 822, such as the peracetic acid pump 822D and the peroxide pump 822E, and the effluent from the floc tube 820. The ORP transmitter 825 measures the influent wastewater after introduction of bicarbonate and automatically modulates at least the peracetic acid pump 822D or the peroxide pump 882E, or both, to maintain a selected target ORP value. The system 800 may also include a pH transmitter 827 in communication with the effluent from the floc tube 820 that, in combination with the ORP transmitter 825, measures the pH level and ORP of the effluent wastewater from the floc tube 820 and automatically modulates the ferric sulfate pump 822A and caustic agent pump 822C to produce an ORP of zero, or around zero and a pH value of 6.2 or less. Then, chitosan can be added by the chitosan pump 822G based on the turbidity of the effluent from the solids recovery unit 826 and to maintain a foamate density that does not hinder foamate recovery.

In some embodiments, there are two primary feed lines from the EQ tanks 814 to the floc tube 820, namely lines B-B and C-C in FIG. 8A and FIG. 8C. Each line B-B and C-C may have an independent flow meter 824, or the lines B-B and C-C may share one flow meter 824, or one of the flow meters 824 may be in fluid communication with both lines B-B and C-C. The flow meters 824 may include some or all of the functionality of the pressure transmitters 806 described herein, such as a display screen for providing a flow reading and in some embodiments, wireless communication of flow rate readings to the system controller or an external device, among other features. In one or more embodiments, the system 800 includes only one line B-B or C-C from the EQ tanks 814 to the floc tube 820 and may include only one corresponding flow meter 824.

The chemically pretreated wastewater from the floc tube 820 or the EQ tanks 814, or both, moves to a solids recovery unit 826, which may be a foam fractionation tower or system of the type described herein. The solids recovery unit 826 uses a gas, such as air or ozone in some non-limiting examples, to create foam that separates particulate solid matter from the pretreated wastewater. The foam containing the particular solid matter is pumped from the solids recovery unit 826 to a foamate tank 828 where the foam settles and returns to an aqueous solution containing solid particles and liquid. In some embodiments, the system 800 includes an antifoam pump 830 between the solids recovery unit 826 and the foamate tank 828 to reduce the foam volume before the foam is received in the foamate tank 828. Further, a caustic agent of the type described herein or an organic compound, such as chitosan in some embodiments, is added at 832 to the solids and liquids in the foamate tank 828.

In some embodiments, the foam remaining in the foamate tank 828, the water from the foamate tank 828, or any combination thereof are pumped back to the solids recovery unit 826 in a fluid loop along line 834 for further processing and removal of solid materials. The system 800 may include a flow control valve 833 in line 834 for selectively controlling fluid flow in line 834 according to various operating modes of the system 800 described herein. The solid matter from the foamate tank 828, which may also include some liquid wastewater, is pumped along line 836 to a sludge tank 838 or one or more decantation tanks 840, or some combination thereof. Where the solid matter from the foamate tank 828 satisfies selected thresholds, such as threshold water percentage, bacterial content or percentage, and others, the solid matter from the foamate tank 828 may travel directly to the sludge tank 838 for holding and eventual disposal at a composition location, among other uses for the recovered solids discussed herein.

Additionally or alternatively, if the solid matter from the foamate tank 828 exceeds certain selected thresholds, the solid matter from the foamate tank 828 may be directed to the one or more decantation tanks 840. At the decantation tanks, the solids are allowed to further settle and separate from the liquids. The decantate from the decantation tanks 840 may be pumped to a UV processing system of the type described herein before being discharged. The recovered solids from the decantation tanks 840 may be removed or pumped out of the tanks 840 and disposed at a compositing location, or another disposal location of the type described herein. In some embodiments, the system 800 includes a level transmitter 842 in communication with the decantate tanks 840 for providing an indication of a fluid level in the decantate tanks 840. As with the pressure transmitters 806, the fluid flow within the system 800 can be adjusted based on the response from the level transmitters 842 and the level transmitters 842 may include a screen for displaying the fluid level for manual inspection, or may transmit the fluid level to the controller of the system 800 through either wired or wireless communication.

The decantate from the decantation tanks 840 is sent back to the solids recovery unit 826, or to a UV processing system, or both, along line 844. Turning to FIG. 8C and with continuing reference to FIG. 8A and FIG. 8B, a recirculation pump 846 is in fluid communication with the solids recovery unit 826 along lines G-G and F-F. An ozone generator 848 is in fluid communication with the recirculation pump 846 to provide ozone to the solids recovery unit 826 and generate foam in the solids recovery unit 826. Further, air may be introduced at 850 (i.e., at a location between the recirculation pump 846 and the ozone generator 850) to further assist with creating foam at the solids recovery unit 826. In some embodiments, the recirculation pump 846 pumps a side stream or a portion of the clean effluent from the bottom of the solids recovery unit 826 and adds air or ozone, or both, to the stream before returning the stream to the solids recovery unit 826 in a loop along line F-F.

The liquid effluent from the solids recovery unit 826 may be sent to a number of different locations. In some embodiments, the effluent from the solids recovery unit 826 travels along line H-H to a UV treatment system 852 that disinfects the effluent from the solids recovery unit 826 before the effluent is discharged to an outfall, as described herein. The system 800 may include a valve 859 in fluid communication with the solids recovery unit 826 and the UV treatment system 852. The valve 859 may control the fluid level in the solids recovery unit 826 (i.e., closing valve 859 increases the fluid level in the recovery unit 826 and opening valve 859 reduces the fluid level in the recovery unit 826). Further, the system 800 may include a flow meter 851 upstream of the UV treatment system 852 for measuring the flow to the UV treatment system 852 and enabling corresponding adjustments. The system 800 may also include one or more third chemical pumps 854 downstream from the flow meter 824 and upstream from the UV treatment system 852 for providing any of the chemical compounds described herein to the effluent from the solids recovery unit 826 before UV treatment at the UV treatment system 852. In a preferred embodiment shown in FIG. 8C, there is only one third chemical pump 854 for providing a caustic agent to the effluent from the solids recovery unit 826 before UV treatment.

The system 800 may also include a pH transmitter 856 and an oxidation reduction potential (“ORP”) transmitter 858 downstream of the UV treatment system 852. Both of the pH transmitter 856 and the ORP transmitter 858 may have features and functionality similar to the other transmitters described herein, namely, the pH transmitter 856 and the ORP transmitter 858 may include a display for manual inspection of a characteristic, or may be in wired or wireless communication with a controller. The pH transmitter 856 measures a pH of the effluent from the UV treatment system 852 to enable adjustment of the chemical pretreatment to ensure that the effluent is an acceptable pH for discharge. Similarly, the ORP transmitter 858 measures the oxidation reduction potential, or reactivity, of the effluent from the UV treatment system 852 to enable adjustments in the Ozone Generator to prevent excessive Ozone residual in the wastewater being discharged through the outfall.

The system 800 includes a UV transmission (“UVT”) transmitter 860 in communication with a valve 861 and the feed pumps upstream of the floc tube 820 (see FIG. 8B). The UVT transmitter 860 is in communication with the feed pumps along line E-E, which is a process control signal line. Further, the UVT transmitter 860 is in communication with the process line or flow line to measure the UV transmission In particular, the UVT transmitter 860 may communicate with the valve 861 and the feed pumps electronically and provide signals or instructions to control the valve 861 and the feed pumps, as described below. The valve 861 is in fluid communication with a secondary flow path connected to a sump pump along line J-J and to the EQ tanks 814 along line D-D. In operation, if the UVT transmitter 860 detects that the UVT of the liquid fraction before processing with the UV treatment system 852 is too low, the UVT transmitter 860 sends instructions to the feed pumps to slow the flow rate through the floc tube 820, the solids recovery unit 826, and the system 800 generally. A slower flow rate allows more residence time for the pretreatment chemicals and processing of the wastewater in the 800 and generally results in an increase in the UVT of the liquid fraction at the transmitter 860. Alternatively, if the UVT transmitter 860 detects that the UVT is above a selected threshold, then the UVT transmitter 860 may send instructions to the feed pumps to increase the flow rate, as a high UVT at the transmitter 860 suggests that the system 800 can process a higher volume of wastewater with less residence time in the system 800 and still achieve the benefits described herein.

The system may further include a turbidity transmitter 863 in communication with the process line or the flow line and the chitosan pump 822G. The turbidity transmitter 863 measures turbidity in the effluent from the solids recovery unit 826 and enables adjustments to the turbidity through the amount of chitosan introduced at the floc tube 820 by the chitosan pump 822G. In particular, if the turbidity transmitter 863 determines that the turbidity in the effluent from the solids recovery unit 826 is above or below selected thresholds, the turbidity transmitter 863 transmits a signal or instructions to the chitosan pump 822G to increase or decrease the amount of chitosan introduced by the chitosan pump 822G at the floc tube 820.

If the UVT of the liquid fraction at the transmitter 860 drops further and passes below a selected threshold, the transmitter 860 sends instructions to open the valve 861 to send the liquid fraction to the wastewater building sump to return the wastewater to the EQ tanks 814 (FIG. 8A) along lines J-J and D-D. The liquid fraction then undergoes further processing at the floc tube 820 and the solids recovery unit 826 until the detected UVT at the UVT transmitter 860 is above the selected threshold. The valve 861 may also be referred to as a solids recovery unit automated drain valve, as the valve 861 drains the solids recovery unit 826 and returns the wastewater to the EQ tanks 814 for further processing based on a signal received from the UVT transmitter 860. In some embodiments, the transmitter 860 may send instructions to the feed pumps to slow the flow rate if the detected UVT of the liquid fraction at the transmitter 860 is less than 60%, less than 50%, or less than 40%. Further, the transmitter 860 may send instructions to open the valve 861 if the detected UVT is less than 40%, less than 30%, or less than 20% in some non-limiting examples. The above percentage ranges are provided merely as non-limiting examples to illustrate the embodiments of the disclosure and in practice, the UVT thresholds for modifying the characteristics of the system may be any value between 0% and 100%.

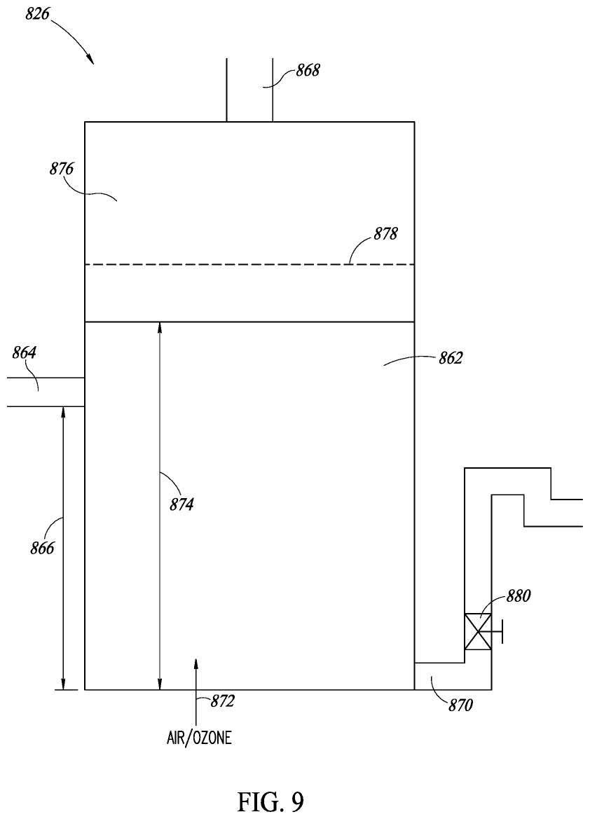

FIG. 9 is a schematic illustration providing additional detail of the solids recovery unit 826 (which may also be referred to herein as a foam fractionation system 826) of the system 800 in FIGS. 8A-8C. The foam fractionation (“FF”) system 826 includes a reservoir 862 with an influent inlet 864 in fluid communication with the floc tube 820 (FIG. 8B) along a side of the reservoir 862 at a selected height relative to the reservoir 862. In some embodiments, the influent inlet 864 is positioned at a height 866 relative to the bottom of the reservoir 862 that may be 75 inches in a preferred embodiment. However, the size of the reservoir 862 and the position of the influent inlet 866 relative to the reservoir 862 may both be selected and thus the height 866 may be more or less than 75 inches in some embodiments. The FF system 826 further includes a foamate outlet 868 at the top of the reservoir 862 and an effluent outlet 870 at the bottom of the reservoir 862. A mix of air and ozone, or only air or only ozone, is fed into the bottom of the reservoir 862 from the recirculation pump 846, the ozone generator 848, and the air inlet 850 (FIG. 8C) as indicated by arrow 872. As described herein, the air and ozone mix creates foam in the reservoir 862 that separates solid particulate matter (dissolved and/or suspended) from liquid. The solid particles are trapped in the foam and exit the reservoir 862 through the foamate outlet 868 for further processing. The liquid effluent travels through outlet 870 for further processing. The influent flow rate and effluent flow rate are adjusted to maintain a liquid column depth (i.e., a depth of the liquid in the reservoir) to a height 874 that is 77″ above the bottom of the reservoir 862 in a preferred embodiment. Thus, the liquid column depth is further from the bottom of the reservoir 862 than the influent inlet 864 by 2 inches in a preferred embodiment, although the liquid column depth and height 874 may be selected to be more or less than 77″ in some embodiments. The foamate occupies the remainder of the space 876 between the top of the liquid column and the top of the reservoir 862. Dashed line 878 represents the addition of an extension ring in the reservoir 862 that may increase foam density. The extension ring 878 increases the height and capacity of the reservoir 862, which allows for additional operational modes. In some embodiments, the extension ring 878 increases the height of the reservoir by 24 inches, although the size of the extension ring may be selected in further embodiments. The flow through the FF system 826 and the operation of the FF system 826 can be adjusted based on several factors. The influent flow rate through inlet 864, in gallons per minute, is preferably set as high as possible in order to increase the processing capacity of the system FF system. The influent flow rate through inlet 864 may be adjusted via the floc tube 820 (FIG. 8B) flow rate set point. After the target influent flow rate is selected, the ozone and air influent at arrow 872, measured in standard cubic feet per minute, is adjusted to produce foam with selected characteristics, such as dry but flowable and collapsible foam. The air influent can be adjusted to eliminate carry over and to remove solid particles in liquid effluent through outlet 870. Further, the ozone influent or the influent rate through inlet 864, or both, can be adjusted based on the height 874 of the liquid column. If the liquid level begins to drop below the target height 874, the ozone influent or the influent rate, or both, may be need to be decreased. Alternatively, the ozone influent rate may need to be increased if the foamate is too wet. Further, the effluent flow rate is controlled by a valve 880, which is preferably set at 100% open to maintain the height 874 of the liquid column, although the same is not required. The valve 880 can be closed to drive out excessive or dry foam, or during cleanup. The valve 880 may also be any percent open between closed (0% open) and 100% open to further adjust the height 874 of the liquid in the FF system 826.

The system 800 enables different wastewater processing methods and operation in several different modes relative to the other systems described herein. In an embodiment, the process begins by treating the wastewater until the EQ tanks 814 are empty, which produces foamate in the decantation tanks 840. The foamate in the decantation tanks 840 is allowed to gravity separate overnight. The following day before treating more wastewater, the sludge layer in the decantation tanks 840 is pumped to the sludge tank 838. The liquid fraction from the decantation tanks 840, or the decantate, is pumped to the Floc Tube 820. If the UVT of the wastewater falls below a certain selected value, as above, the wastewater can be recycled back through the floc tube 820 for additional processing. If the UVT is above a certain selected threshold, the wastewater is treated at the UV treatment system 852 and is discharged to an outfall. The above summary of the process is one non-limiting example and additional operational variations for the system are summarized below in Table 3.

TABLE 3

| | Pre- | Caustic | | All | EQ tank | E [symbol] | Settled sludge | EQ Tank |
|---|---|---|---|---|---|---|---|---|
| | Dosing | added at | Caustic | Chemicals | pumped same | Tank | pumped to | Supernatant |
| Mode of | (Fe and | [symbol] loc | added at | at [symbol] loc | day (SD) or | allowed to | Decant Tank (DT) | Pump to |
| Operation | PAA only) | Tube | EQ tank | Tube | Next day (ND) | settle | or Tower (T) | Tower |
| Run [symbol] loc | No | No | No | Yes | SD | No | N/A | N/A |
| Tube & Tower in | | | | | | | | |
| Real Time | | | | | | | | |
| Pre-does day of, | Yes | Yes | No | No | ND | No | N/A | N/A |
| add Caustic day | | | | | | | | |
| after in [symbol] loc | | | | | | | | |
| tube, Tower [symbol] | | | | | | | | |
| ND | | | | | | | | |
| Pre-does day of, | Yes | Yes | No | No | SD | No | N/A | N/A |
| add Caustic day | | | | | | | | |
| of in [symbol] loc Tube, | | | | | | | | |
| Tower [symbol] SD | | | | | | | | |
| Pre-dose day of, | Yes | No | Yes | No | SD | No | N/A | N/A |
| add Caustic day of | | | | | | | | |
| in EQ tank pump | | | | | | | | |
| EQ tank to Tower, | | | | | | | | |
| Tower [symbol] SD | | | | | | | | |
| Pre-does day of, | Yes | No | Yes | No | SD | Yes | T | Yes |
| add Caustic day | | | | | | | | |
| of in EQ tank, | | | | | | | | |
| pump stratified EQ | | | | | | | | |
| tank to tower, | | | | | | | | |
| tower [symbol] SD | | | | | | | | |
| Pre-dose day of, | Yes | No | Yes | No | SD | Yes | DT | Yes |
| add Caustic day | | | | | | | | |
| of in EQ tank, | | | | | | | | |
| pump sludge to | | | | | | | | |
| Decant tank, | | | | | | | | |
| tower [symbol] SD | | | | | | | | |
| Pre-dose day of, | Yes | No | Yes | No | ND | Yes | T | Yes |
| add Caustic day | | | | | | | | |
| of in EQ tank, | | | | | | | | |
| pump stratified EQ | | | | | | | | |
| tank to tower, | | | | | | | | |
| tower [symbol] ND | | | | | | | | |
| Pre-dose day of, | Yes | No | Yes | No | ND | Yes | DT | Yes |
| add Caustic day | | | | | | | | |
| of in EQ tank, | | | | | | | | |
| pump sludge to | | | | | | | | |
| Decant tank, | | | | | | | | |
| tower [symbol] ND | | | | | | | | |

[symbol]

indicates data missing or illegible when filed

As shown in Table 3, there at least eight different modes of operation enabled by system 800, although the present disclosure is not limited to the operational modes shown in Table 3. In the discussion below, “same day” or “day of” refers to a period within 24 hours and more preferably within 12 hours of the stated event. In one non-limiting example, pumping the EQ tanks 814 “same day” or “day of” refers to pumping the wastewater from the EQ tanks 814 within 24 hours and more preferably within 12 hours of the wastewater arriving at the EQ tanks 814. Similarly, “next day” refers to a period of more than 12 hours and in some embodiments, more than 24 hours, after the stated event, such as performing the activity on the next day of operation.

In a first mode of operation (row 1 in Table 3) and with continuing reference to FIGS. 8A-8C, the floc tube 820 and the FF system 826 are run in real time based on an influent of wastewater. There is no pre-dosing of the wastewater by the first chemical pumps 816 and a caustic agent is not added at the floc tube 820 or the EQ tanks 814. Rather, all chemicals are added at the floc tube 820 via second chemical pumps 822. The EQ tanks 814 are pumped the same day of operation and the wastewater is not allowed to settle in the EQ tanks 814. The advantages of the first mode of operation include a reduction in the number of tanks, such as EQ tanks 814, in the system 800 and no carry-over of operations or wastewater to the next operating day or time.

In a second mode of operation (row 2 in Table 3), there is a pre-dose of chemicals day of, the caustic agent is added the day after at the floc tube 820, and the FF system 826 is run next day. More specifically, a pre-dose of ferric sulfate and peracetic acid are added to the wastewater the day of operation at the first chemical pumps 816 and a caustic agent is introduced to the wastewater at the floc tube 820 by second chemical pumps 822 the next day. The caustic agent is not added to the wastewater at the EQ tanks 814 in some embodiments. As a result, all the chemicals are not added at the floc tube 820 and in some embodiments, no chemicals are added at the floc tube 820. The EQ tanks 814 are pumped next day but are not allowed to settle, such as through periodic agitation with the mixers in the EQ tanks 814. The FF system 826 is operated next day. The advantages of the second mode of operation include additional contact time for the ferric sulfate and peracetic acid as well as additional adjustments of the system 800. In some non-limiting examples, the ferric sulfate and peracetic acid can adjusted before pumping to the floc tube 820 and the caustic agent addition can be tested before pumping to the floc tube 820.

A third mode of operation (row 3 in Table 3) is the same as the second mode of operation described above, except the caustic agent is added day of at the floc tube 820, the FF system 826 is run the same day, and the EQ tanks 814 are pumped same day. The third mode of operation advantageously reduces the number of tanks, such as EQ tanks 814, in the system 800 while also increasing contact time for ferric sulfate and peracetic acid, and eliminating carry-over of operations to the next day.

A fourth mode of operation (row 4 in Table 3) includes chemical pre-dosing day of, adding a caustic agent day of in the EQ tanks 814, pumping the EQ tanks 814 to the FF system 826, and running the system 826 same day. In this mode of operation, ferric sulfate and peracetic acid are added via the first chemical pumps 816, the caustic agent is not added at the floc tube 820, but rather at the EQ tanks 814, and the EQ tanks 814 are pumped same-day without settling. This mode of operation advantageously reduces the number of tanks or does not utilize additional tanks, there is no carry over to the next day of operations, there is more contact time for the ferric sulfate and peracetic acid, and the caustic agent addition can be tested before adding to the EQ tanks 814.

A fifth mode of operation (row 5 in Table 3) may generally be the same as the fourth mode of operation above, except that the EQ tanks 814 are allowed to settle and the settled sludge is pumped to the FF system 826 along with the supernatant from the EQ tanks 814. In addition to the benefits above, the fifth mode of operation allows for operation at higher flow rates of the supernatant from the EQ tanks 814 and may result in a faster tank cycle time overall.

A sixth mode of operation (row 6 in Table 3) may be similar to the fifth mode of operation, except the settled sludge from the EQ tanks 814 is pumped to the decantation tanks 840 instead of to the FF system 826. This mode of operation advantageously reduces the risk that the settled sludge will impact or not be processed by the FF system 826 while also allowing the FF system 826 to run at a high flow rate on the supernatant from the EQ tanks 814.

A seventh mode of operation (row 7 in Table 3) may be similar to the fifth mode of operation, except the FF system 826 is run next day instead of same day as in the fifth mode of operation. In some embodiments, the seventh mode of operation employs additional tanks but also increase the contact time for the ferric sulfate and peracetic acid.

An eighth mode of operation (row 8 in Table 3) may be similar to the sixth mode of operation, except the FF system is run next day instead of the same day as in the sixth mode. This method may similarly employ additional tanks, but increases the contact time for ferric sulfate and peracetic acid while also allowing for additional testing of the caustic addition and reducing the risks associated with pumping the sludge to the FF system 826.

The above modes of operation, including whether they are performed next day, same day, or back to back, are impacted by a number of factors such as the speed of the floc formation, the size of the floc, the rate of settling or separation, and the clarity of the supernatant from the EQ tanks 814. The factors that affect floc formation and settling time may include salinity, temperature, organic load, pH or oxidation reduction potential, or both, black sludge, alkalinity, mixing energy and duration, chemicals used and dosing levels, order of chemical addition, peracetic acid concentration, and ozone concentration in some non-limiting examples. The modes of operation above, as well as operation of the system 800 optimize these factors to produce the results discussed herein for the influent of wastewater. In addition, the present disclosure contemplates further modifications to system 800 based on a number of factors. For example, the optimal foam fractionation tower height and diameter, optimal wastewater flow rate, automation of the wastewater flow control, optimal ozone and air flow rates, optimal method for introducing the gases into the foam fractionation tower, automation of the flow control valve on the foam fractionation tower, and optimal foam properties, such as how to achieve the driest foamate using foamate refluxing and/or addition of a caustic agent and/or chitosan, are currently under development and may result in changes or variations in the system 800. Thus, the present disclosure is not limited to the examples described herein and further variations to the system 800 based on the above factors are expressly included in the disclosure.

As will be readily appreciated from the foregoing, the present disclosure achieves a system and method for recovering solids from wastewater wherein the wastewater effluent has significantly lower concentrations of pollutants, chemicals, bacteria, and viruses. The effluent can be discharged to treatment plants for further processing or directly to existing bodies of water with significantly reduced environmental impacts. The recovered solids can be used as feeds and fertilizer.

In the above description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wastewater processing systems and methods have not been shown or described in detail to avoid unnecessarily obscuring descriptions of the embodiments.

As used herein, unless the context dictates otherwise, the term “line” shall be construed as meaning “a device for conveying fluids” and includes, without limitation, tubes, pipes, conduits, hoses, mains, ducts, channels, canals, conveyors, pipelines, drains, tubing, piping, siphons, and hollow cylinders.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

In some embodiments, components or modules of the systems described herein are implemented using standard programming techniques. For example, the logic to perform the functionality of the various embodiments or implementations described herein may be implemented as a “native” executable running on the controller, along with one or more static or dynamic libraries. In other embodiments, various functions of the controller may be implemented as instructions processed by a virtual machine that executes as one or more programs whose instructions are stored on ROM and/or random RAM. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the controller, such as a microprocessor, to perform the functions of the controller. The instructions cause the microprocessor or some other processor, such as an I/O controller/processor, to process and act on information received from one or more transmitters to provide the functionality and operations described herein.

The embodiments described above may also use well-known or other synchronous or asynchronous client-server computing techniques. However, the various components may be implemented using more monolithic programming techniques as well, for example, as an executable running on a single microprocessor, or alternatively decomposed using a variety of structuring techniques known in the art, including but not limited to, multiprogramming, multithreading, client-server, or peer-to-peer (e.g., Bluetooth®, NFC or RFID wireless technology, mesh networks, etc., providing a communication channel between the devices within the systems), running on one or more computer systems each having one or more central processing units (CPUs) or other processors. Some embodiments may execute concurrently and asynchronously, and communicate using message passing techniques.

In addition, programming interfaces to the data stored on and functionality provided by the controller, can be available by standard mechanisms such as through C, C++, C#, and Java APIs; libraries for accessing files, databases, or other data repositories; scripting languages; or Web servers, FTP servers, or other types of servers providing access to stored data. The data stored and utilized by the controller and overall systems may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules within the systems in different ways, yet still achieve the functions of the controller and systems described herein.

Furthermore, in some embodiments, some or all of the components within the systems may be implemented or provided in other manners, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Application No. 63/253,937 filed Oct. 8, 2021, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-24. (canceled)

25. A method comprising:
pretreating wastewater containing organic matters, the pretreating including adding one or more pretreatment chemicals to the wastewater to form a pretreated wastewater mixture, wherein the one or more pretreatment chemicals are metal-based coagulants, pH adjusters, oxidants or a combination thereof; and
supplying the pretreated wastewater mixture into a foam fractionation system, whereby the pretreated wastewater mixture is separated into a foamate and an effluent within the foam fractionation system, wherein the foamate comprises foams on which at least a portion of the organic matters are adsorbed.

26. The method of claim 25 wherein the metal-based coagulant is ferric sulfate; the pH adjuster is sodium bicarbonate, sodium hydroxide, or sulfuric acid; and the oxidant is hydrogen peroxide, peracetic acid or a combination thereof.

27. The method of claim 25 wherein the pretreating includes passing the wastewater containing organic matters through a floc tube and supplying the pretreated wastewater mixture into the foam fractionation system in real-time based on an influent of the wastewater containing organic matters.

28. The method of claim 27 wherein the pretreating includes introducing all of the one or more pretreatment chemicals at the floc tube to form the pretreated wastewater mixture.

29. The method of claim 27 further comprising:
before the pretreating the wastewater containing organic matters, storing the influent of the wastewater containing organic matters in one or more equalization tanks in fluid communication with the floc tube for less than 12 hours.

30. The method of claim 25 wherein the one or more pretreatment chemicals includes at least a first pretreatment chemical and at least a second pretreatment chemical, the pretreating the wastewater containing organic matters includes adding at least the first pretreatment chemical to the wastewater upstream of a floc tube and at least the second pretreatment chemical to the wastewater at the floc tube.

31. The method of claim 30 wherein the adding the at least the first pretreatment chemical includes adding at least the first pretreatment chemical to the wastewater at least 12 hours in advance of adding the at least the second pretreatment chemical to the wastewater.

32. The method of claim 30 wherein the pretreating the wastewater containing organic matters occurs at least 12 hours before supplying the pretreated wastewater mixture to the foam fractionation system.

33. The method of claim 30 further comprising:
before the pretreating the wastewater containing organic matters, storing the influent of the wastewater containing organic matters in one or more equalization tanks in fluid communication with the floc tube for less than 12 hours.

34. The method of claim 33 wherein the adding at least the first pretreatment chemical to the wastewater includes adding at least the first pretreatment chemical to the wastewater at the one or more equalization tanks.

35. The method of claim 29 further comprising:
before supplying the pretreated wastewater mixture into the foam fractionation system, allowing the wastewater containing organic matters to settle in the one or more equalization tanks for a period of time, the settling including separating solid matter from liquid in the wastewater.

36. The method of claim 35 further comprising:
before supplying the pretreated wastewater mixture into the foam fractionation system, pumping the solid matter from the one or more equalization tanks to one or more decantation tanks.

37. A system, comprising:
a chemical pretreatment system, the chemical pretreatment system including:
one or more equalization tanks;
a floc tube in fluid communication with the one or more equalization tanks;
at least one chemical pump in fluid communication with at least one of the one or more equalization tanks and the floc tube; and
a foam fractionation system in fluid communication with the chemical pretreatment system, the foam fractionation system including:
a reservoir having a fluid inlet, a fluid outlet, and a foamate outlet, the reservoir further including a first end;
a gas injection pump in fluid communication with the reservoir through a fluid loop coupled between the gas injection pump and the first end of the reservoir; and
a gas source upstream of the gas injection pump and in fluid communication with the gas injection pump.

38. The system of claim 37 wherein the at least one chemical pump includes one or more first chemical pumps and one or more second chemical pumps, the one or more first chemical pumps in fluid communication with the one or more equalization tanks and the one or more second chemical pumps in fluid communication with the floc tube.

39. The system of claim 38 wherein the one or more first chemical pumps provides ferric sulfate or peracetic acid, or both, to wastewater in the one or more equalization tanks.

40. The system of claim 38 wherein the one or more second chemical pumps provides at least one of ferric sulfate, sodium bicarbonate, sodium hydroxide, sulfuric acid, hydrogen peroxide, peracetic acid or a combination thereof to wastewater in the floc tube.

41. The system of claim 37 wherein the at least one chemical pump includes a plurality of first chemical pumps upstream of the one or more equalization tanks and a plurality of second chemical pumps at the floc tube.

42. The system of claim 41 wherein the plurality of first chemical pumps and the plurality of second chemical pumps provide pretreatment chemicals to wastewater in the chemical pretreatment system, the pretreatment chemicals including metal-based coagulants, pH adjusters, oxidants, caustic agents, or a combination thereof.

43. The system of claim 42 wherein the pretreatment chemicals include ferric sulfate, peracetic acid, citric acid, sodium hydroxide, calcium hydroxide, sodium bicarbonate, sulfuric acid, and hydrogen peroxide.
